(19) United States
(12) Patent Application Publication
(10) Pub. No.: US 2025/0330203 A1
(43) Pub. Date: Oct. 23, 2025

(54) RADIO FREQUENCY MODULE

(71) Applicant: Murata Manufacturing Co., Ltd., Nagaokakyo-shi (JP)

(72) Inventors: Keisuke ARIMA, Nagaokakyo-shi (JP); Hiroaki TAKAOKA, Nagaokakyo-shi (JP); Hidetaka TAKAHASHI, Nagaokakyo-shi (JP); Rui TANAKA, Nagaokakyo-shi (JP); Gouki KAWAKAMI, Nagaokakyo-shi, Kyoto (JP); Shotaro MANAGO, Nagaokakyo-shi (JP); Yukiya YAMAGUCHI, Nagaokakyo-shi (JP)

(73) Assignee: Murata Manufacturing Co., Ltd., Nagaokakyo-shi (JP)

(21) Appl. No.: 19/021,739

(22) Filed: Jan. 15, 2025

(30) Foreign Application Priority Data
Apr. 18, 2024 (JP) 2024-067730

(51) Int. Cl. H04B 1/00

(52) U.S. Cl. CPC H04B 1/0064

(57) ABSTRACT

A radio frequency module includes a first switch having a selection terminal connected to an antenna and a second selection terminal connected to an antenna and a first common terminal; a second switch having third and fourth selection terminals and a second common terminal; two filters; an inductor connected to a common path connecting the first and second common terminals; an inductor connected to a first path connecting the third selection terminal to the first filter; and an inductor connected to a second path connecting the fourth selection terminal to the filter. The distance between the first and second inductors is shorter than the distance between the first and third inductors.

### CROSS-REFERENCE TO RELATED APPLICATION

This application claims priority to Japanese Patent Application No. JP 2024-067730 filed on Apr. 18, 2024. The entire contents of the above-identified applications, including the specifications, drawings and claims, are incorporated herein by reference in their entirety.

### BACKGROUND OF THE INVENTION

### 1. Field of the Invention

The present invention relates to a radio frequency module.

### 2. Description of the Related Art

In International Publication No. 2017/006866, a front end module having a configuration in which a first inductance element connected to a signal path through which signals in a low band group are transmitted and a second inductance element connected to a signal path through which signals in a high band group are transmitted are electromagnetically coupled so that second harmonic wave components propagating through the signal path for the high band group are canceled, is disclosed.

### SUMMARY OF THE INVENTION

As multiband technology has been advancing, radio frequency modules with less transmission loss of signals in multiple bands have been demanded.

Accordingly, the present invention has been designed to solve the problem mentioned above, and it is a feature of the present invention to provide a radio frequency module with less transmission loss of signals in multiple bands.

In order to achieve the feature mentioned above, a radio frequency module according to an aspect of the present invention includes a first switch that includes a first selection terminal connected to a first antenna, a second selection terminal connected to a second antenna, and a first common terminal; a second switch that includes a third selection terminal, a fourth selection terminal, and a second common terminal; a first filter and a second filter; a first inductor that is connected to a common path connecting the first common terminal to the second common terminal; a second inductor that is connected to a first path connecting the third selection terminal to the first filter; and a third inductor that is connected to a second path connecting the fourth selection terminal to the second filter. A distance between the first inductor and the second inductor is shorter than a distance between the first inductor and the third inductor.

Furthermore, a radio frequency module according to an aspect of the present invention includes a first switch that includes a first selection terminal connected to a first antenna, a second selection terminal connected to a second antenna, and a first common terminal; a second switch that includes a third selection terminal, a fourth selection terminal, and a second common terminal; a first filter and a second filter; a first inductor that is connected to a common path connecting the first common terminal to the second common terminal; a second inductor that is connected to a first path connecting the third selection terminal to the first filter; and a third inductor that is connected to a second path connecting the fourth selection terminal to the second filter. An angle formed between a winding axis positive direction of the first inductor and a winding axis positive direction of the second inductor is smaller than an angle formed between the winding axis positive direction of the first inductor and a winding axis positive direction of the third inductor.

Furthermore, a radio frequency module according to an aspect of the present invention includes a first switch that includes a first selection terminal connected to a first antenna, a second selection terminal connected to a second antenna, and a first common terminal; a second switch that includes a third selection terminal, a fourth selection terminal, and a second common terminal; a first filter and a second filter; a first inductor that is connected to a common path connecting the first common terminal to the second common terminal; a second inductor that is connected to a first path connecting the third selection terminal to the first filter; a third inductor that is connected to a second path connecting the fourth selection terminal to the second filter; and a metal member that is disposed between the first inductor and the third inductor.

According to the present invention, a radio frequency module with less transmission loss of signals in multiple bands can be provided.

### BRIEF DESCRIPTION OF THE DRAWINGS

FIG. 1A is a circuit configuration diagram of a radio frequency module and a communication apparatus according to an embodiment for Band A reception;

FIG. 1B is a circuit configuration diagram of the radio frequency module and the communication apparatus according to the embodiment for Band B reception;

FIG. 1C is a circuit configuration diagram of the radio frequency module and the communication apparatus according to the embodiment for Band A and Band C simultaneous reception;

FIG. 1D is a circuit configuration diagram of the radio frequency module and the communication apparatus according to the embodiment for the case where a diversity circuit is used;

FIG. 2 includes a plan view and a cross-section view of the radio frequency module according to the embodiment;

FIG. 3 is a plan view of a radio frequency module according to a first modification of the embodiment;

FIG. 4 includes a plan view and a cross-section view of a radio frequency module according to a second modification of the embodiment;

FIG. 5A is a circuit configuration diagram of a radio frequency module according to a third modification of the embodiment for Band A reception;

FIG. 5B is a circuit configuration diagram of the radio frequency module according to the third modification of the embodiment for Band B reception;

FIG. 5C is a circuit configuration diagram of the radio frequency module according to the third modification of the embodiment for Band C reception;

FIG. 6 is a graph indicating bandpass characteristics of a low pass filter of the radio frequency module according to the third modification of the embodiment;

FIG. 7A is a circuit configuration diagram of a radio frequency module according to a fourth modification of the embodiment for Band A transmission;

FIG. 7B is a circuit configuration diagram of the radio frequency module according to the fourth modification of the embodiment for Band A reception;

FIG. 7C is a circuit configuration diagram of a radio frequency module according to a comparative example for Band A transmission; and

FIG. 8 is a graph indicating bandpass characteristics of a low pass filter of each of the radio frequency module according to the fourth modification of the embodiment and the radio frequency module according to the comparative example.

### DESCRIPTION OF THE PREFERRED EMBODIMENTS

Embodiments of the present disclosure will be described in detail below with reference to drawings. The embodiments described below each illustrate a comprehensive or specific example. The numerical values, shapes, materials, component elements, arrangements of the component elements, manners in which the component elements are connected, and so on illustrated in the embodiments described below are merely examples and are not intended to limit the present invention. Among the component elements in the embodiments described below, component elements that are not described in independent claims are described as optional component elements. In addition, the sizes of or the size ratios between the component elements illustrated in the drawings are not necessarily precise.

The drawings are schematic diagrams in which emphasis, omission, or ratio adjustment is performed in an appropriate manner in order that the present invention is illustrated. The drawings are not necessarily illustrated precisely and may differ from actual shapes, positional relationships, and ratios. In the drawings, substantially the same configurations are denoted by the same reference signs, and repetitive description may be omitted or simplified.

In a circuit configuration in the present disclosure, “being connected” not only represents being directly connected by a connection terminal and/or a wiring conductor but also includes being electrically connected with a matching element or a switch circuit interposed therebetween. “Being connected between A and B” represents being connected between A and B and to both A and B.

In the present invention, a “terminal” represents a point at which a conductor inside an element terminates. In the case where the impedance of a conductor between elements is sufficiently low, a terminal is not necessarily construed as a single point but is also construed as a point (node) in the conductor between the elements or the entire conductor.

Furthermore, in the present disclosure, a “signal path” and a “common path” represent transmission paths including a wire through which a radio frequency transmission signal or a radio frequency reception signal propagates, an electrode directly connected to the wire, a terminal directly connected to the wire or the electrode, and the like.

Furthermore, in arrangement of circuit elements in the present disclosure, “a circuit element A is arranged in series to a path B” represents the state in which a signal input end and a signal output end of the circuit element A is connected to each of two wires configuring at least part of the path B. At least one of the two wires may be an electrode or a terminal.

Furthermore, in the present disclosure, a plan view of a substrate means viewing a substrate and a circuit element mounted at the substrate by orthographic projection onto a plane parallel to a main surface of the substrate.

Furthermore, in component arrangement in the present disclosure, “a component is disposed at a substrate” includes the state in which a component is disposed on a main surface of a substrate and the state in which a component is disposed inside a substrate. “A component is disposed on a main surface of a substrate” includes the state in which a component is disposed in contact with a main surface of a substrate and the state in which a component is disposed above a main surface without being in contact with the main surface (for example, a component is stacked on another component that is disposed in contact with a main surface). Furthermore, “a component is disposed on a main surface of a substrate” may include the case where a component is disposed in a recessed part formed in a main surface. “A component is disposed inside a substrate” includes the state in which a component is encapsulated in a module substrate, the state in which part of a component is not covered with a substrate although the entire component is disposed between both the main surfaces of the substrate, and the state in which only part of a component is disposed inside a substrate.

Furthermore, in component arrangement in the present disclosure, “winding axis positive directions are the same” not only represents the state in which the angle formed between vector components in winding axis positive directions is 0 degrees but also includes cases where winding axis positive directions are substantially the same, for example, cases where the angle formed between vector components of winding axis positive directions is within the range of plus/minus 30 degrees.

Furthermore, in embodiments described below, a pass band of a filter is defined as a frequency range between two frequencies that are higher than the minimum value of insertion loss by 3 dB in the pass band.

Furthermore, in the present disclosure, a “band” represents at least one of an uplink operating band and a downlink operating band of frequency bands defined in advance by standardization organizations or other bodies (for example, 3GPP (registered trademark), Institute of Electrical and Electronics Engineers (IEEE), etc.) for a communication system established using radio access technology (RAT). In an embodiment, for example, a long term evolution (LTE) system, a 5th generation-new radio (5G-NR) system, a wireless local area network (WLAN) system, or the like can be used as a communication system. However, the communication system is not limited to the systems mentioned above. An uplink operating band of a frequency band represents a frequency range specified for uplink of the frequency band. A downlink operating band of a frequency band represents a frequency range specified for downlink of the frequency band.

### EMBODIMENT

### 1 Circuit Configuration of Radio Frequency Module 1 and Communication Apparatus 4

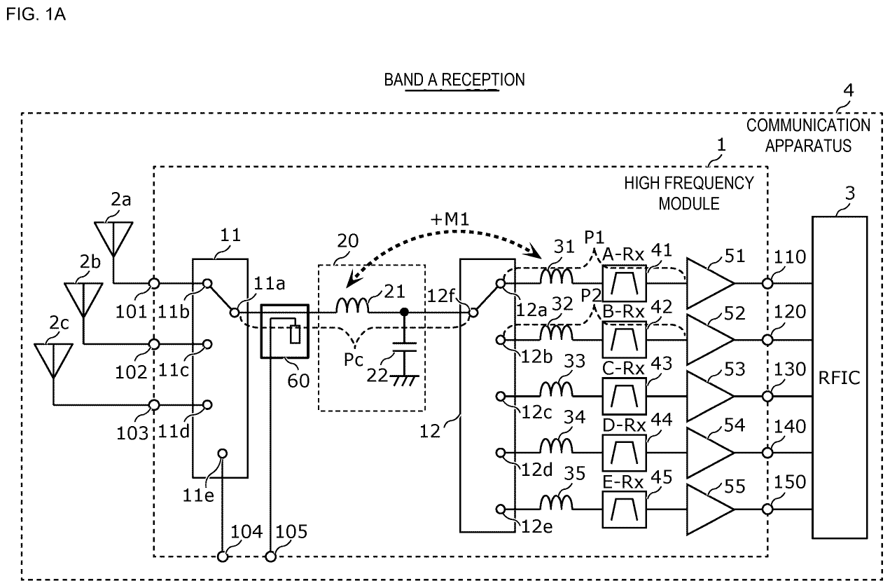

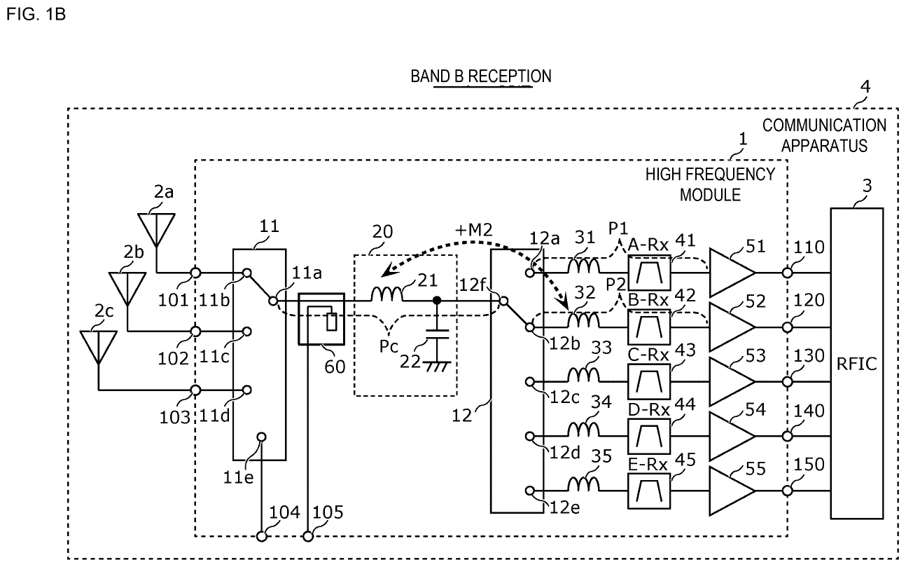

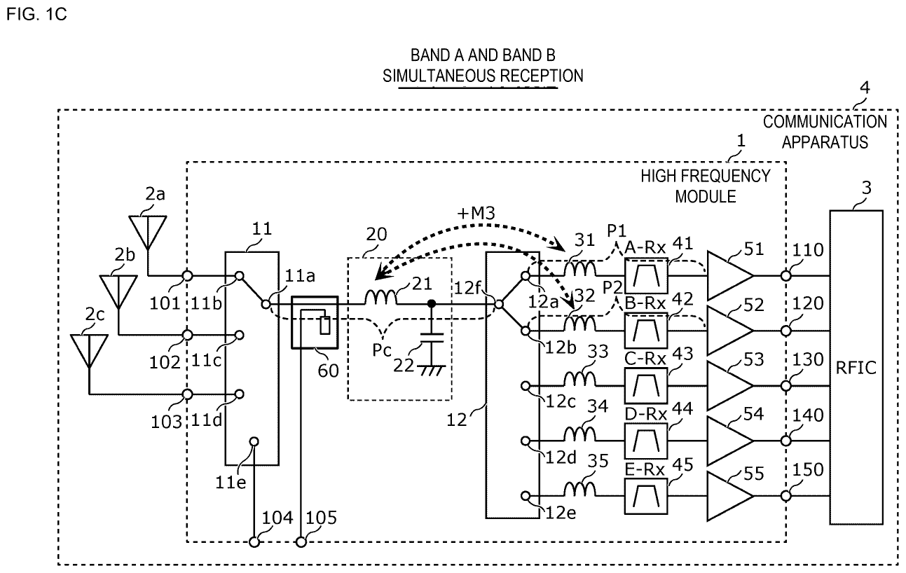

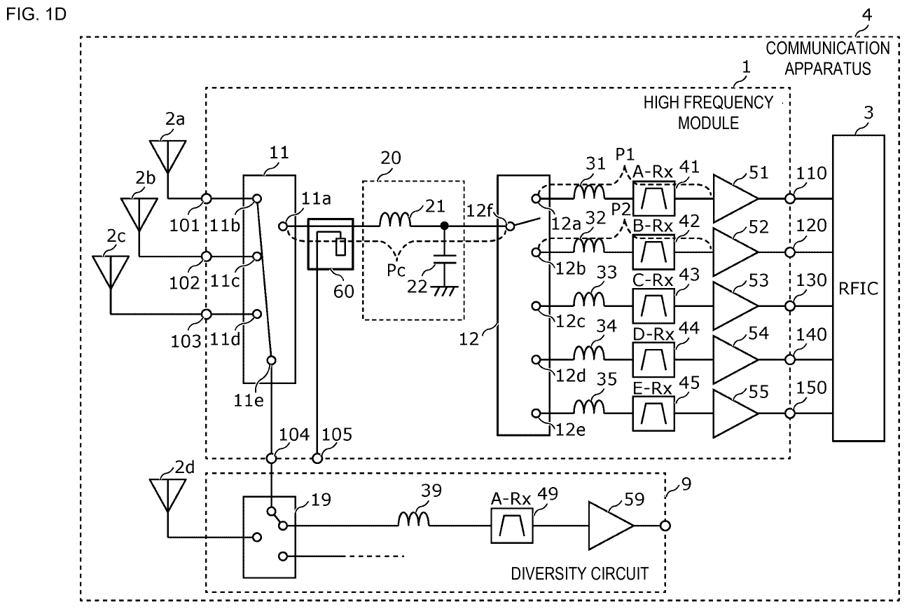

A circuit configuration of a radio frequency module 1 and a communication apparatus 4 according to an embodiment will be described with reference to FIGS. 1A to 1D. FIG. 1A is a circuit configuration diagram of the radio frequency module 1 and the communication apparatus 4 according to this embodiment for Band A reception. FIG. 1B is a circuit configuration diagram of the radio frequency module 1 and the communication apparatus 4 according to this embodiment for Band B reception. FIG. 1C is a circuit configuration diagram of the radio frequency module 1 and the communication apparatus 4 according to this embodiment for Band A and Band B simultaneous reception. FIG. 1D is a circuit configuration diagram of the radio frequency module 1 and the communication apparatus 4 according to this embodiment for the case where a diversity circuit is used.

As illustrated in FIGS. 1A to 1D, the communication apparatus 4 includes the radio frequency module 1, antennas 2a, 2b, and 2c, and an RF signal processing circuit (radio frequency integrated circuit (RFIC)) 3.

The radio frequency module 1 transmits radio frequency signals between the antennas 2a to 2c and the RFIC 3. The circuit configuration of the radio frequency module 1 will be described in detail below.

The antenna 2a is an example of a first antenna and is connected to an antenna connection terminal 101 of the radio frequency module 1. The antenna 2a receives a radio frequency signal from the outside and outputs the radio frequency signal to the radio frequency module 1. The antenna 2b is an example of a second antenna and is connected to an antenna connection terminal 102 of the radio frequency module 1. The antenna 2b receives a radio frequency signal from the outside and outputs the radio frequency signal to the radio frequency module 1. The antenna 2c is connected to an antenna connection terminal 103 of the radio frequency module 1. The antenna 2c receives a radio frequency signal from the outside and outputs the radio frequency signal to the radio frequency module 1. The antennas 2a to 2c may output radio frequency signals output from the radio frequency module 1 to the outside.

The RFIC 3 is an example of a signal processing circuit that processes a radio frequency signal. Specifically, the RFIC 3 performs signal processing such as down-conversion on a reception signal received through a reception path for the radio frequency module 1, and outputs a reception signal generated by the signal processing to a baseband signal processing circuit (a.k.a, baseband integrated circuit (BBIC), not illustrated in the drawing). The RFIC 3 may perform signal processing such as up-conversion on a transmission signal received from the BBIC and output a transmission signal generated by the signal processing to a transmission path for the radio frequency module 1.

Furthermore, the RFIC 3 controls switching of connection of switches 11 and 12 of the radio frequency module 1 and functions as a controller that controls power supply voltage and bias voltage (current) supplied to low noise amplifiers 51 to 55. Part of or the entire function of the RFIC 3 as the controller may be implemented outside the RFIC 3, for example, in the BBIC or the radio frequency module 1.

The antennas 2a to 2c are not necessarily included in the communication apparatus 4.

Next, the circuit configuration of the radio frequency module 1 will be described. As illustrated in FIGS. 1A to 1D, the radio frequency module 1 includes the switches 11 and 12, filters 41, 42, 43, 44, and 45, inductors 21, 31, 32, 33, 34, and 35, a capacitor 22, the low noise amplifiers 51, 52, 53, 54, and 55, a coupler 60, the antenna connection terminals 101, 102, and 103, an external connection terminal 104, and signal output terminals 105, 110, 120, 130, 140, and 150.

The antenna connection terminal 101 is an example of a first antenna connection terminal and is connected to the antenna 2a and a selection terminal 11b of the switch 11. The antenna connection terminal 102 is an example of a second antenna connection terminal and is connected to the antenna 2b and a selection terminal 11c of the switch 11. The antenna connection terminal 103 is connected to the antenna 2c and a selection terminal 11d of the switch 11. The external connection terminal 104 is connected to a selection terminal lie of the switch 11. The signal output terminal 105 is connected to a sub-line of the coupler 60. The signal output terminal 110 is connected to an output end of the low noise amplifier 51 and the RFIC 3. The signal output terminal 120 is connected to an output end of the low noise amplifier 52 and the RFIC 3. The signal output terminal 130 is connected to an output end of the low noise amplifier 53 and the RFIC 3. The signal output terminal 140 is connected to an output end of the low noise amplifier 54 and the RFIC 3. The signal output terminal 150 is connected to an output end of the low noise amplifier 55 and the RFIC 3.

The filter 41 is an example of a first filter and has a pass band including a reception band of Band A. A first end of the filter 41 is connected to the inductor 31, and a second end of the filter 41 is connected to an input end of the low noise amplifier 51. The filter 42 is an example of a second filter and has a pass band including a reception band of Band B. A first end of the filter 42 is connected to the inductor 32, and a second end of the filter 42 is connected to an input end of the low noise amplifier 52. The filter 43 has a pass band including a reception band of Band C. A first end of the filter 43 is connected to the inductor 33, and a second end of the filter 43 is connected to an input end of the low noise amplifier 53. The filter 44 has a pass band including a reception band of Band D. A first end of the filter 44 is connected to the inductor 34, and a second end of the filter 44 is connected to an input end of the low noise amplifier 54. The filter 45 has a pass band including a reception band of Band E. A first end of the filter 45 is connected to the inductor 35, and a second end of the filter 45 is connected to an input end of the low noise amplifier 55. The structures of the filters 41 to 45 are not particularly limited. The filters 41 to 45 may be, for example, acoustic wave filters including an acoustic wave resonator, LC filters including an inductor and a capacitor, or the like. The filters 43 to 45 are not necessarily included in the radio frequency module 1.

The switch 11 is an example of a first switch and includes a common terminal 11a (first common terminal), the selection terminal 11b (first selection terminal), the selection terminal 11c (second selection terminal), and the selection terminals 11d and lie (external connection terminals). The switch 11 switches between connection and disconnection between the common terminal 11a and the selection terminal 11b, switches between connection and disconnection between the common terminal 11a and the selection terminal 11c, switches between connection and disconnection between the common terminal 11a and the selection terminal 11d, switches between connection and disconnection between the selection terminal 11b and the selection terminal lie, switches between connection and disconnection between the selection terminal 11c and the selection terminal lie, and switches between connection and disconnection between the selection terminal 11d and the selection terminal lie. The common terminal 11a is connected to a common terminal 12f of the switch 12 with a common path Pc interposed therebetween, the selection terminal 11b is connected to the antenna 2a with the antenna connection terminal 101 interposed therebetween, the selection terminal 11c is connected to the antenna 2b with the antenna connection terminal 102 interposed therebetween, the selection terminal 11d is connected to the antenna 2c with the antenna connection terminal 103 interposed therebetween, and the selection terminal lie is connected to an external circuit (diversity circuit 9) with the external connection terminal 104 interposed therebetween. The selection terminals 11d and lie are not necessarily included in the switch 11.

The switch 12 is an example of a second switch and includes the common terminal 12f (second common terminal), a selection terminal 12a (third selection terminal), a selection terminal 12b (fourth selection terminal), and selection terminals 12c, 12d, and 12e. The switch 12 switches between connection and disconnection between the common terminal 12f and the selection terminal 12a, switches between connection and disconnection between the common terminal 12f and the selection terminal 12b, switches between connection and disconnection between the common terminal 12f and the selection terminal 12c, switches between connection and disconnection between the common terminal 12f and the selection terminal 12d, and switches between connection and disconnection between the common terminal 12f and the selection terminal 12e. The common terminal 12f is connected to the common terminal 11a with the common path Pc interposed therebetween, the selection terminal 12a is connected to the inductor 31, the selection terminal 12b is connected to the inductor 32, the selection terminal 12c is connected to the inductor 33, the selection terminal 12d is connected to the inductor 34, and the selection terminal 12e is connected to the inductor 35. The selection terminals 12c, 12d, and 12e are not necessarily included in the switch 12.

The inductor 21 is an example of a first inductor and is connected to the common path Pc connecting the common terminal 11a to the common terminal 12f. More specifically, a first end of the inductor 21 is connected to the common terminal 11a, and a second end of the inductor 21 is connected to the common terminal 12f.

The capacitor 22 is an example of a first capacitor and is connected between the common path Pc and the ground. In this embodiment, the capacitor 22 is connected to a part of the common path Pc that is between the inductor 21 and the common terminal 12f. However, the capacitor 22 may be connected to a part of the common path Pc that is between the inductor 21 and the common terminal 11a.

The inductor 21 and the capacitor 22 form a low pass filter 20. The capacitor 22 is not necessarily provided. Furthermore, the inductor 21 may be connected between the common path Pc and the ground. Furthermore, in the case where the capacitor 22 is not provided, the inductor 21 may function as an impedance matching circuit.

The inductor 31 is an example of a second inductor and is connected to a signal path P1 (first path) that connects the selection terminal 12a to the filter 41. More specifically, a first end of the inductor 31 is connected to the selection terminal 12a, and a second end of the inductor 31 is connected to the filter 41. The inductor 31 may be connected between the signal path P1 and the ground.

The inductor 32 is an example of a third inductor and is connected to a signal path P2 (second path) that connects the selection terminal 12b to the filter 42. More specifically, a first end of the inductor 32 is connected to the selection terminal 12b, and a second end of the inductor 32 is connected to the filter 42. The inductor 32 may be connected between the signal path P2 and the ground.

The inductor 33 is connected to a signal path that connects the selection terminal 12c to the filter 43. More specifically, a first end of the inductor 33 is connected to the selection terminal 12c, and a second end of the inductor 33 is connected to the filter 43. The inductor 33 may be connected between the signal path and the ground. The inductor 34 is connected to a signal path that connects the selection terminal 12d to the filter 44. More specifically, a first end of the inductor 34 is connected to the selection terminal 12d, and a second end of the inductor 34 is connected to the filter 44. The inductor 34 may be connected between the signal path and the ground. The inductor 35 is connected to a signal path that connects the selection terminal 12e to the filter 45. More specifically, a first end of the inductor 35 is connected to the selection terminal 12e, and a second end of the inductor 35 is connected to the filter 45. The inductor 35 may be connected between the signal path and the ground. The inductors 33 to 35 are not necessarily included in the radio frequency module 1.

The inductor 21 and the inductor 31 are configured in such a manner that magnetic field coupling can be achieved between the inductor 21 and the inductor 31. Furthermore, the inductor 21 and the inductor 32 are configured in such a manner that magnetic field coupling can be achieved between the inductor 21 and the inductor 32.

The input end of the low noise amplifier 51 is connected to the filter 41, and the output end of the low noise amplifier 51 is connected to the signal output terminal 110. The low noise amplifier 51 is capable of amplifying signals in the reception band of Band A. The input end of the low noise amplifier 52 is connected to the filter 42, and the output end of the low noise amplifier 52 is connected to the signal output terminal 120. The low noise amplifier 52 is capable of amplifying signals in the reception band of Band B. The input end of the low noise amplifier 53 is connected to the filter 43, and the output end of the low noise amplifier 53 is connected to the signal output terminal 130. The low noise amplifier 53 is capable of amplifying signals in the reception band of Band C. The input end of the low noise amplifier 54 is connected to the filter 44, and the output end of the low noise amplifier 54 is connected to the signal output terminal 140. The low noise amplifier 54 is capable of amplifying signals in the reception band of Band D. The input end of the low noise amplifier 55 is connected to the filter 45, and the output end of the low noise amplifier 55 is connected to the signal output terminal 150. The low noise amplifier 55 is capable of amplifying signals in the reception band of Band E. The low noise amplifiers 51 to 55 may be a single low noise amplifier capable of amplifying reception signals in Bands A to E. Furthermore, the low noise amplifiers 51 to 55 are not necessarily included in the radio frequency module 1.

The coupler 60 is disposed on the common path Pc and is capable of measuring power of a signal transmitted through the common path Pc. The coupler 60 includes a main line and the sub-line that are electromagnetically coupled to each other. The main line is arranged on the common path Pc, a first end of the sub-line is terminated, and a second end of the sub-line is connected to the signal output terminal 105.

Accordingly, by disposing the single coupler 60, which measures power of a signal, on the common path Pc, power of signals transmitted through a plurality of signal paths for corresponding Bands A to E can be measured. Thus, the size of the radio frequency module 1 can be reduced.

Next, regarding the radio frequency module 1, a case (1) where a signal in Band A is received (Band A reception mode), a case (2) where a signal in Band B is received (Band B reception mode), a case (3) where signals in Band A and Band B are received at the same time (Band A and Band B simultaneous reception mode), and a case (4) where a signal is received by an external circuit (external circuit reception mode) will be described with reference to FIGS. 1A to 1D.

First, as illustrated in FIG. 1A, in the Band A reception mode (1), the common terminal 11a and the selection terminal 11b are connected and the common terminal 12f and the selection terminal 12a are connected. In this circuit state, a signal in Band A travels through the antenna 2a, the switch 11, the low pass filter 20, the switch 12, the inductor 31, the filter 41, and the low noise amplifier 51 and is output through the signal output terminal 110. At this time, since the signal travels through the inductors 21 and 31, magnetic field coupling is achieved between the inductor 21 and the inductor 31, and a mutual inductance (+M1) (first mutual inductance) is thus generated. Accordingly, the inductance value of the low pass filter 20 (common path Pc) is defined as a value obtained by adding up an inductance value L21 of the inductor 21 and +M1. Furthermore, the inductance value of the signal path P1 is defined as a value obtained by adding up an inductance value L31 of the inductor 31 and +M1.

In the Band A reception mode (1), a signal in Band A is not necessarily received by the antenna 2a. A signal in Band A may be received by the antenna 2b or 2c. In this case, the common terminal 11a and the selection terminal 11c are connected or the common terminal 11a and the selection terminal 11d are connected.

Next, as illustrated in FIG. 1B, in the Band B reception mode (2), the common terminal 11a and the selection terminal 11b are connected and the common terminal 12f and the selection terminal 12b are connected. In this circuit state, a signal in Band B travels through the antenna 2a, the switch 11, the low pass filter 20, the switch 12, the inductor 32, the filter 42, and the low noise amplifier 52 and is output through the signal output terminal 120. At this time, since the signal travels through the inductors 21 and 32, magnetic field coupling is achieved between the inductor 21 and the inductor 32, and a mutual inductance (+M2) (second mutual inductance) is thus generated. Accordingly, the inductance value of the low pass filter 20 (common path Pc) is defined as a value obtained by adding up the inductance value L21 of the inductor 21 and +M2. Furthermore, the inductance value of the signal path P2 is defined as a value obtained by adding up an inductance value L32 of the inductor 32 and +M2.

In the Band B reception mode (2), a signal in Band B is not necessarily received by the antenna 2a. A signal in Band B may be received by the antenna 2b or 2c. In this case, the common terminal 11a and the selection terminal 11c are connected or the common terminal 11a and the selection terminal 11d are connected.

In known radio frequency modules, in order to arrange low pass filters that are optimized for individual signal paths through which signals in multiple bands are transmitted, the low pass filters are disposed on a path that connects the antenna 2a to the switch 11, a path that connects the antenna 2b to the switch 11, and a path that connects the antenna 2c to the switch 11.

In contrast, in the radio frequency module 1 according to this embodiment, in the Band A reception mode and the Band B reception mode, the plurality of signal paths that connect the antennas 2a to 2c to the filters 41 to 45 share the common path Pc, and the single low pass filter 20 is disposed on the common path Pc. Accordingly, no chip-like inductor is connected to the path that connects the antenna connection terminal 101 to the switch 11, the path that connects the antenna connection terminal 102 to the switch 11, or the path that connects the antenna connection terminal 103 to the switch 11.

Thus, since matching elements for achieving impedance matching between the antennas 2a to 2c and the radio frequency module 1 can share the single inductor 21 that is disposed on the common path Pc, the size of the radio frequency module 1 can be reduced.

Furthermore, by achieving magnetic field coupling between the inductor 21 of the low pass filter 20 and each of the inductors 31 to 35 disposed on individual signal paths, the pass band width of the low pass filter 20, the frequency of an attenuation pole, and the like can be optimized for each of the signal paths for Bands A to E. For example, in the Band A reception mode, magnetic field coupling is achieved between the inductors 21 and 31, and the mutual inductance (+M1) is generated. In the Band B reception mode, magnetic field coupling is achieved between the inductors 21 and 32, and the mutual inductance (+M2), which is different from the mutual inductance (+M1), is generated. By causing the mutual inductances mentioned above to be generated, an effective inductance value of the common path Pc can be set larger than the inductance value of the inductor 21, an effective inductance value of the signal path P1 can be set larger than the inductance value of the inductor 31, and an effective inductance value of the signal path P2 can be set larger than the inductance value of the inductor 32. Thus, since the inductance values of the inductors 21 and 31 can be decreased by the mutual inductance (+M1) and the inductance values of the inductors 21 and 32 can be decreased by the mutual inductance (+M2), resistance loss in the inductors 21, 31, and 32 can be reduced, and transmission loss in the signal path for Band A and the signal path for Band B can be reduced.

Next, as illustrated in FIG. 1C, in the Band A and Band B simultaneous reception mode (3), the common terminal 11a and the selection terminal 11b are connected, the common terminal 12f and the selection terminal 12a are connected, and the common terminal 12f and the selection terminal 12b are connected. In this circuit state, a signal in Band A travels through the antenna 2a, the switch 11, the low pass filter 20, the switch 12, the inductor 31, the filter 41, and the low noise amplifier 51 and is output through the signal output terminal 110. At the same time, a signal in Band B travels through the antenna 2a, the switch 11, the low pass filter 20, the switch 12, the inductor 32, the filter 42, and the low noise amplifier 52 and is output through the signal output terminal 120. At this time, since the signals travel through the inductors 21, 31, and 32, magnetic field coupling is achieved between the inductor 21 and the inductors 31 and 32, and a mutual inductance (+M3) is generated. Accordingly, the inductance value of the low pass filter 20 (common path Pc) is defined as a value obtained by adding up the inductance value L21 of the inductor 21 and +M3. Furthermore, the inductance value of the signal path P1 is defined as a value obtained by adding up the inductance value L31 of the inductor 31 and +M1, and the inductance value of the signal path P2 is defined as a value obtained by adding up the inductance value L32 of the inductor 32 and +M2.

In the Band A and Band B reception mode (3), signals in Band A and Band B are not necessarily received by the antenna 2a. A signal in at least one of Band A and Band B may be received by the antenna 2b or 2c. In this case, the common terminal 11a and the selection terminal 11c are connected and/or the common terminal 11a and the selection terminal 11d are connected.

Next, as illustrated in FIG. 1D, in the external circuit reception mode (4), the selection terminal 11b and the selection terminal lie are connected. In this circuit state, a signal in Band A travels through the antenna 2a, the switch 11, and the external connection terminal 104 and is output to the diversity circuit 9, which is an external circuit provided outside the radio frequency module 1. The diversity circuit 9 includes, for example, a switch 19, an inductor 39, a filter 49, and a low noise amplifier 59. A signal in Band A that has traveled through the switch 11 of the radio frequency module 1 travels through the switch 19, the inductor 39, the filter 49, and the low noise amplifier 59 and is output to, for example, the RFIC 3. Since the switch 11 has the selection terminal lie, the signal in Band A that is transmitted through the diversity circuit 9 does not pass through the low pass filter 20. Therefore, transmission loss in the signal path that connects the antennas 2a to 2c to the diversity circuit 9 can be reduced.

In the external circuit reception mode (4), a signal in Band A is not necessarily received by the antenna 2a. A signal in Band A may be received by the antenna 2b or 2c. In this case, the common terminal 11a and the selection terminal 11c are connected or the common terminal 11a and the selection terminal 11d are connected.

### 2 Arrangement Configuration of Components of Radio Frequency Module 1

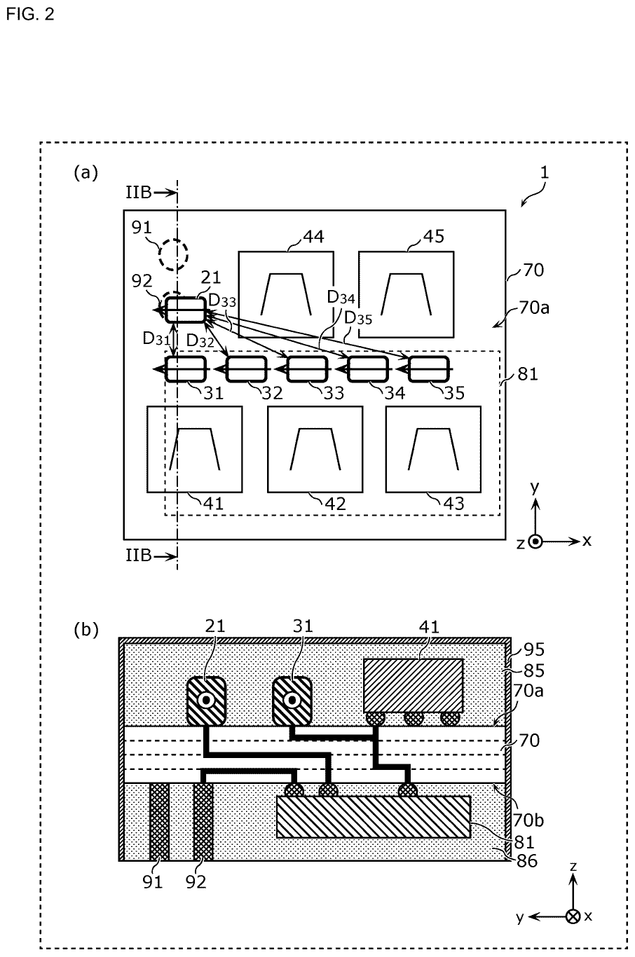

Next, an arrangement configuration of components of the radio frequency module 1 according to this embodiment will be described. FIG. 2 includes a plan view and a cross-section view of the radio frequency module 1 according to this embodiment. In part (a) of FIG. 2, an arrangement of circuit components in the case where a main surface 70a of a module substrate 70 is seen from a z-axis positive direction is illustrated. In part (a) of FIG. 2, circuit components disposed on a main surface 70b of the module substrate 70 are indicated by broken lines. Furthermore, in part (b) of FIG. 2, a cross-section view along line IIB-IIB in part (a) of FIG. 2 is illustrated. In FIG. 2, part of illustration of wires connecting the module substrate 70 to circuit components is omitted. Furthermore, in FIG. 2, for easier understanding of the arrangement relationship of filters, symbols representing functions of the filters are provided. However, the symbols are not provided on the actual filters.

The radio frequency module 1 illustrated in FIG. 2 further includes the module substrate 70, resin members 85 and 86, and a shield electrode layer 95, in addition to the configuration of the radio frequency module 1 illustrated in FIGS. 1A to 1D.

The module substrate 70 is a substrate that has the main surface 70a (first main surface) and the main surface 70b (second main surface) that are opposite to each other, and circuit components configuring the radio frequency module 1 are mounted at the substrate. For example, a low temperature co-fired ceramics (LTCC) substrate, a high temperature co-fired ceramics: HTCC) substrate, a substrate including components built therein, a substrate including a redistribution layer (RDL), a printed wiring board, or the like that has a multilayer structure including a plurality of dielectric layers is used as the module substrate 70.

As illustrated in FIG. 2, the filters 41 to 45 and the inductors 21 and 31 to 35 are disposed on the main surface 70a. Furthermore, a semiconductor IC 81 and external connection terminals 91 and 92 are disposed on the main surface 70b. Although the low noise amplifiers 51 to 55, the coupler 60, and the capacitor 22 are not illustrated in FIG. 2, these components may be disposed at the module substrate 70.

The semiconductor IC 81 is an example of a first semiconductor IC and includes the switch 11 and the switch 12. For example, the semiconductor IC 81 may include a complementary metal oxide semiconductor (CMOS). Specifically, the semiconductor IC 81 may be produced by a silicon on insulator (SOI) process. Furthermore, the semiconductor IC 81 may be made of at least one of GaAs, SiGe, and GaN. A semiconductor material of the semiconductor IC 81 is not limited to the materials mentioned above.

Accordingly, since the circuit components configuring the radio frequency module 1 are disposed on both surfaces of the module substrate 70 in a distributed manner, the size of the radio frequency module 1 can be reduced.

Each of the inductors 21 and 31 to 35 is, for example, a surface-mounted chip inductor. Each of the inductors 21 and 31 to 35 may include a planar coil conductor formed at the module substrate 70.

As illustrated in part (a) of FIG. 2, a distance D₃₁ between the inductor 21 and the inductor 31 is shorter than a distance D₃₂ between the inductor 21 and the inductor 32.

Accordingly, the mutual inductance (+M1) generated by magnetic field coupling between the inductor 21 and the inductor 31 and the mutual inductance (+M2) generated by magnetic field coupling between the inductor 21 and the inductor 32 can be made different from each other. Furthermore, in the case where the inductance value of the inductor 31 and the inductance value of the inductor 32 are substantially equal, the mutual inductance (+M1) can be set larger than the mutual inductance (+M2).

Accordingly, the inductance value of the common path Pc can be set larger than the inductance value of the inductor 21, the inductance value of the signal path P1 can be set larger than the inductance value of the inductor 31, and the inductance value of the signal path P2 can be set larger than the inductance value of the inductor 32. Therefore, since the inductance values of the inductors 21 and 31 can be decreased by the mutual inductance (+M1) and the inductance values of the inductors 21 and 32 can be decreased by the mutual inductance (+M2), resistance loss in the inductors 21, 31, and 32 can be reduced, and transmission loss in the signal path for Band A and the signal path for Band B can be reduced. Furthermore, since the mutual inductance (+M1) and the mutual inductance (+M2) can be made different from each other, the inductance value of the common path Pc can be set separately for the case where a signal in Band A is transmitted and the case where a signal in Band B is transmitted.

Furthermore, as illustrated in part (a) of FIG. 2, the winding axis positive direction of the inductor 21 (x-axis negative direction), the winding axis positive direction of the inductor 31 (x-axis negative direction), and the winding axis positive direction of the inductor 32 (x-axis negative direction) may be the same.

Accordingly, the mutual inductance (+M1) and the mutual inductance (+M2) can be positive values. Furthermore, by adjusting the distance D₃₁ and the distance D₃₂, the size relationship between the mutual inductance (+M1) and the mutual inductance (+M2) can be defined. In this embodiment, since distance D₃₁ is shorter than the distance D₃₂, the mutual inductance (+M1) can be set larger than the mutual inductance (+M2).

In the case where an inductor is a surface-mounted chip component, the winding axis of the inductor is the winding axis of a coil formed inside the component. Furthermore, in the case where an inductor is a planar coil formed at the module substrate 70, the winding axis of the inductor is an axis that is perpendicular to a plane including the planar coil and intersects a region surrounded by the planar coil.

The direction of the winding axis of an inductor is defined as described below. In the case where a coil configuring an inductor is seen from a direction that goes from a first side to a second side of the winding axis thereof, when a current flows clockwise (rightward direction) in the coil, the winding axis positive direction is defined as a direction that goes from the first side to the second side of the winding axis and the winding axis negative direction is defined as a direction that goes from the second side to the first side of the winding axis.

The resin member 85 is arranged to cover the main surface 70a, the filters 41 to 45, and the inductors 21 and 31 to 35. The resin member 86 is arranged to cover the main surface 70b and the semiconductor IC 81.

The shield electrode layer 95 is formed to cover a surface of the resin member 85, a side surface of the resin member 86, and a side surface of the module substrate 70 and is set to a ground potential.

At least one of the resin members 85 and 86 and the shield electrode layer 95 is not necessarily provided.

As illustrated in part (a) of FIG. 2, in the case where the module substrate 70 is seen in plan view, the inductors 31 and 32 and the semiconductor IC 81 overlap. Accordingly, since wires connected to the selection terminals 12a and 12b side of the switch 12 can be shortened, transmission loss in the radio frequency module 1 can be reduced. In one embodiment, at least one of the inductors 31 and 32 and the semiconductor IC 81 may overlap.

Furthermore, although not illustrated in the drawing, in the case where the module substrate 70 is seen in plan view, the inductor 21 and the semiconductor IC 81 may overlap. Accordingly, since a wire connected to the common terminal 12f side of the switch 12 can be shortened, transmission loss in the radio frequency module 1 can be reduced.

### 3 Arrangement Configuration of Components of Radio Frequency Module 1A According to First Modification

Next, an arrangement configuration of components of a radio frequency module 1A according to a first modification will be described. The radio frequency module 1A according to this modification includes switches 11 and 12, filters 41 to 45, inductors 21, 31, 32A, 33, 34, and 35, a capacitor 22, low noise amplifiers 51 to 55, a coupler 60, antenna connection terminals 101 to 103, an external connection terminal 104, signal output terminals 105 and 110 to 150, a module substrate 70, resin members 85 and 86, and a shield electrode layer 95. The radio frequency module 1A according to this modification is different from the radio frequency module 1 according to the embodiment only in the arrangement configuration of the inductor 32. Hence, description of configuration features of the radio frequency module 1A according to this modification that are the same as those of the radio frequency module 1 according to the embodiment will be omitted, and different configuration features will be mainly described below.

The inductor 32A is an example of a third inductor and is connected to the signal path P2 that connects the selection terminal 12b to the filter 42. More specifically, a first end of the inductor 32A is connected to the selection terminal 12b, and a second end of the inductor 32A is connected to the filter 42.

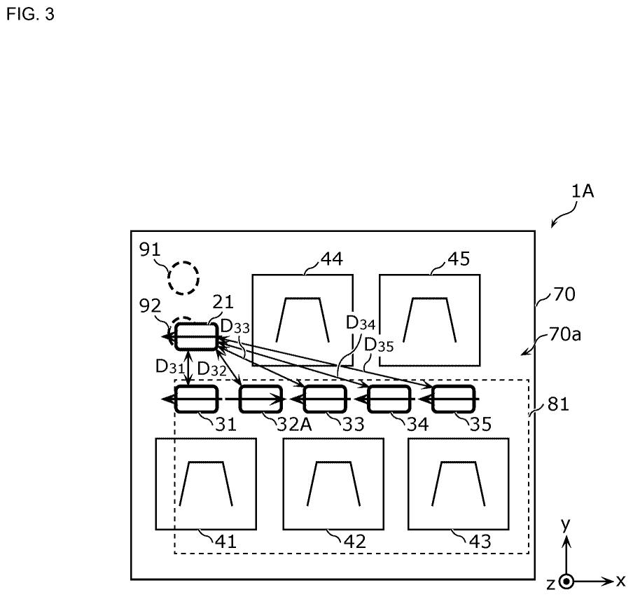

FIG. 3 is a plan view of the radio frequency module 1A according to the first modification of the embodiment. As illustrated in FIG. 3, the filters 41 to 45 and the inductors 21, 31, 32A, 33, 34, and 35 are disposed on the main surface 70a. Furthermore, the semiconductor IC 81 and the external connection terminals 91 and 92 are disposed on the main surface 70b. Although the low noise amplifiers 51 to 55, the coupler 60, and the capacitor 22 are not illustrated in FIG. 3, these components may be disposed at the module substrate 70.

Accordingly, since the circuit components configuring the radio frequency module 1A are disposed on both surfaces of the module substrate 70 in a distributed manner, the size of the radio frequency module 1A can be reduced.

Each of the inductors 21, 31, 32A, 33, 34, and 35 is, for example, a surface-mounted chip inductor. Each of the inductors 21, 31, 32A, 33, 34, and 35 may be a planar coil conductor formed at the module substrate 70.

As illustrated in FIG. 3, the winding axis positive direction of the inductor 21 (x-axis negative direction) and the winding axis positive direction of the inductor 31 (x-axis negative direction) are the same, and the winding axis positive direction of the inductor 21 (x-axis negative direction) and the winding axis negative direction of the inductor 32A (x-axis negative direction) are the same.

Accordingly, the mutual inductance (+M1) generated by magnetic field coupling between the inductor 21 and the inductor 31 and the mutual inductance (−M2) generated by magnetic field coupling between the inductor 21 and the inductor 32A can be made different from each other. Furthermore, in the case where the inductance values of the inductor 31 and the inductor 32A are substantially equal, the mutual inductance (+M1) can be set larger than the mutual inductance (−M2).

Accordingly, the inductance value of the common path Pc can be set larger than the inductance value of the inductor 21, and the inductance value of the signal path P1 can be set larger than the inductance value of the inductor 31. Therefore, since the inductance values of the inductors 21 and 31 can be decreased by the mutual inductance (+M1), resistance loss in the inductors 21 and 31 can be reduced, and transmission loss in the signal path for Band A can be reduced. Furthermore, since the mutual inductance (+M1) and the mutual inductance (−M2) can be made different from each other, the inductance value of the common path Pc can be set separately for the case where a signal in Band A is transmitted and the case where a signal in Band B is transmitted.

In this modification, the winding axis positive direction of the inductor 31 and the winding axis positive direction of the inductor 21 are the same and the winding axis positive direction of the inductor 32A and the winding axis positive direction of the inductor 21 are opposite. However, instead of this arrangement configuration, the angle formed between the winding axis positive direction of the inductor 21 and the winding axis positive direction of the inductor 31 may be set smaller than the angle formed between the winding axis positive direction of the inductor 21 and the winding axis positive direction of the inductor 32A.

Accordingly, the inductance value of the common path Pc can be set larger than the inductance value of the inductor 21, and the inductance value of the signal path P1 can be set larger than the inductance value of the inductor 31. Therefore, since the inductance values of the inductors 21 and 31 can be decreased by the mutual inductance (+M1) generated by magnetic field coupling between the inductor 21 and the inductor 31, resistance loss in the inductors 21 and 31 can be reduced, and transmission loss in the signal path for Band A can be reduced. Furthermore, since the mutual inductance (+M1) generated by magnetic field coupling between the inductor 21 and the inductor 31 can be set larger than the mutual inductance (+M2) generated by magnetic field coupling between the inductor 21 and the inductor 32A, the inductance value of the common path Pc can be set separately for the case where a signal in Band A is transmitted and the case where a signal in Band B is transmitted.

Furthermore, as illustrated in FIG. 3, the distance D₃₁ between the inductor 21 and the inductor 31 may be shorter than the distance D₃₂ between the inductor 21 and the inductor 32A.

Accordingly, the mutual inductance (+M1) and the mutual inductance (+M2) can be made largely different from each other. Furthermore, in the case where the inductance values of the inductor 21 and the inductor 31 are substantially equal, the mutual inductance (+M1) can be made larger than the mutual inductance (+M2).

Furthermore, as illustrated in FIG. 3, in the case where the module substrate 70 is seen in plan view, the inductors 31 and 32A and the semiconductor IC 81 overlap. Accordingly, since wires connected to the selection terminals 12a and 12b side of the switch 12 can be shortened, transmission loss in the radio frequency module 1A can be reduced. Only at least one of the inductors 31 and 32A and the semiconductor IC 81 need to overlap.

Furthermore, although not illustrated in the drawing, in the case where the module substrate 70 is seen in plan view, the inductor 21 and the semiconductor IC 81 may overlap. Accordingly, since a wire connected to the common terminal 12f side of the switch 12 can be shortened, transmission loss in the radio frequency module 1A can be reduced.

### 4 Arrangement Configuration of Components of Radio Frequency Module 1B According to Second Modification

Next, an arrangement configuration of components of a radio frequency module 1B according to a second modification will be described. The radio frequency module 1B according to this modification includes switches 11 and 12, filters 41 to 45, inductors 21 and 31 to 35, a capacitor 22, low noise amplifiers 51 to 55, a coupler 60, antenna connection terminals 101 to 103, an external connection terminal 104, signal output terminals 105 and 110 to 150, a module substrate 70, resin members 85 and 86, a shield electrode layer 95, and a ground metal plate 93. The radio frequency module 1B according to this modification is different from the radio frequency module 1 according to the embodiment only in that the ground metal plate 93 is disposed. Hence, description of configuration features of the radio frequency module 1B according to this modification that are the same as those of the radio frequency module 1 according to the embodiment will be omitted, and different configuration features will be mainly described below.

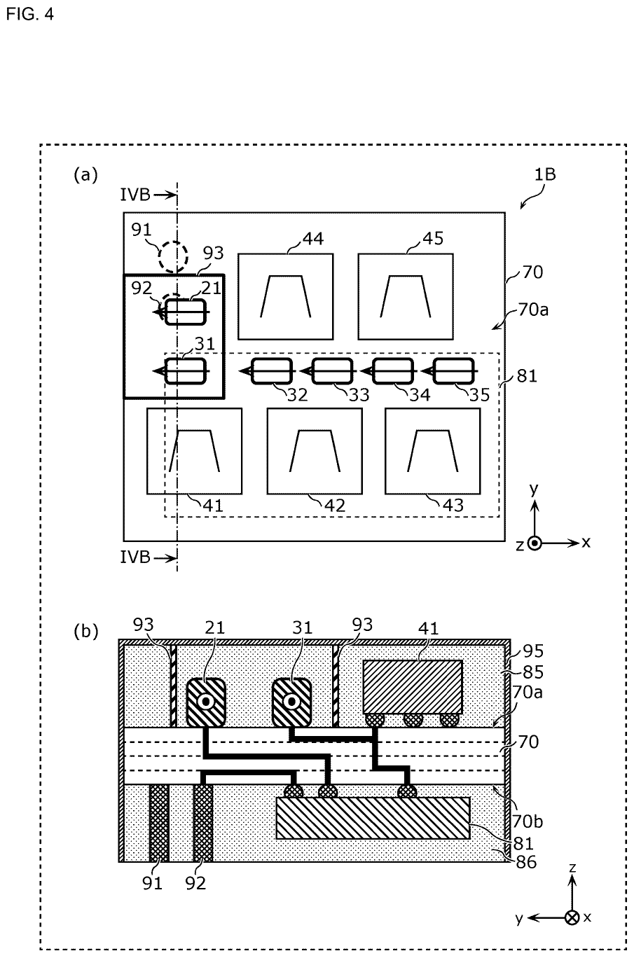

FIG. 4 includes a plan view and a cross-section view of the radio frequency module 1B according to the second modification of the embodiment. As illustrated in FIG. 4, the filters 41 to 45, the inductors 21 and 31 to 35, and the ground metal plate 93 are disposed on the main surface 70a. Furthermore, the semiconductor IC 81 and the external connection terminals 91 and 92 are disposed on the main surface 70b. Although the low noise amplifiers 51 to 55, the coupler 60, and the capacitor 22 are not illustrated in FIG. 4, these components may be disposed at the module substrate 70.

Accordingly, since the circuit components configuring the radio frequency module 1B are disposed on both surfaces of the module substrate 70 in a distributed manner, the size of the radio frequency module 1B can be reduced.

The ground metal plate 93 is an example of a metal member and is provided upright between the inductors 21 and 31 and the inductor 32 on the main surface 70a. More specifically, the ground metal plate 93 is provided upright on the main surface 70a so as to surround the inductors 21 and 31. The ground metal plate 93 may be bonded to the shield electrode layer 95, as illustrated in part (b) of FIG. 4, or may be connected to a ground layer formed inside the module substrate 70.

Accordingly, since the ground metal plate 93 is disposed between the inductor 21 and the inductor 32, the mutual inductance (+M2) generated by magnetic field coupling between the inductor 21 and the inductor 32 can be set smaller than the mutual inductance (+M1) generated by magnetic field coupling between the inductor 21 and the inductor 31.

The size of the mutual inductance (+M1) and the mutual inductance (+M2) can be adjusted by the distance D₃₁ between the inductor 21 and the inductor 31, the distance D₃₂ between the inductor 21 and the inductor 32, and the winding axis directions of the inductors 31 and 32.

Accordingly, the inductance value of the common path Pc can be set larger than the inductance value of the inductor 21, and the inductance value of the signal path P1 can be set larger than the inductance value of the inductor 31. Therefore, since the inductance values of the inductors 21 and 31 can be decreased by the mutual inductance (+M1), resistance loss in the inductors 21 and 31 can be reduced, and transmission loss in the signal path for Band A can be reduced. Furthermore, since the mutual inductance (+M1) and the mutual inductance (+M2) can be made different from each other, the inductance value of the common path Pc can be set separately for the case where a signal in Band A is transmitted and the case where a signal in Band B is transmitted.

In this modification, the ground metal plate 93 is provided upright on the main surface 70a so as to surround the inductors 21 and 31. However, the ground metal plate 93 may be provided upright so as not to surround the inductors 21 and 31 but to surround the inductor 32. Furthermore, a metal member that isolate the inductors 21 and 31 from the inductor 32 is not necessarily the ground metal plate 93 but may be, for example, a circuit element including a conductor member such as an electrode.

Furthermore, a ground metal plate that isolates the filters 41 to 45 from the inductors 21 and 31 to 35 may be disposed on the main surface 70a. Accordingly, electromagnetic field coupling between the inductors 21 and 31 to 35 and the filters 41 to 45 can be suppressed while magnetic field coupling between the inductor 21 and the inductors 31 to 35 being maintained.

### 5 Configuration of Radio Frequency Module 1C According to Third Modification

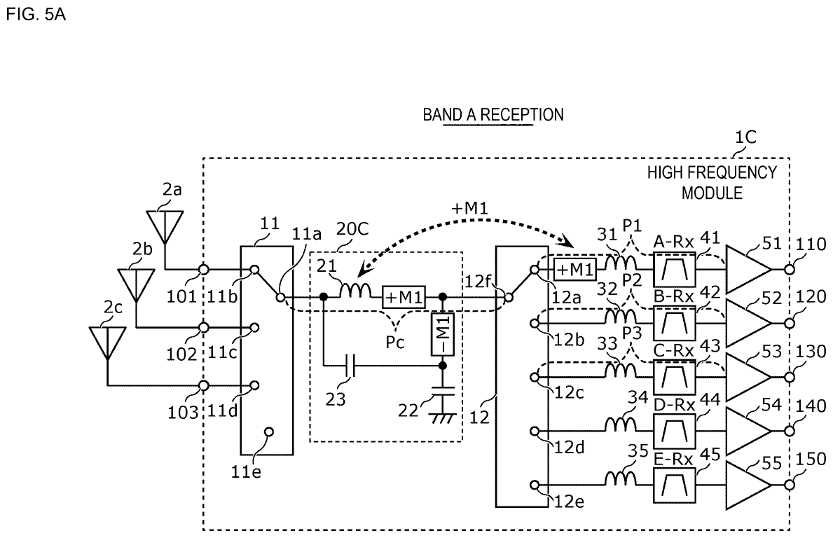

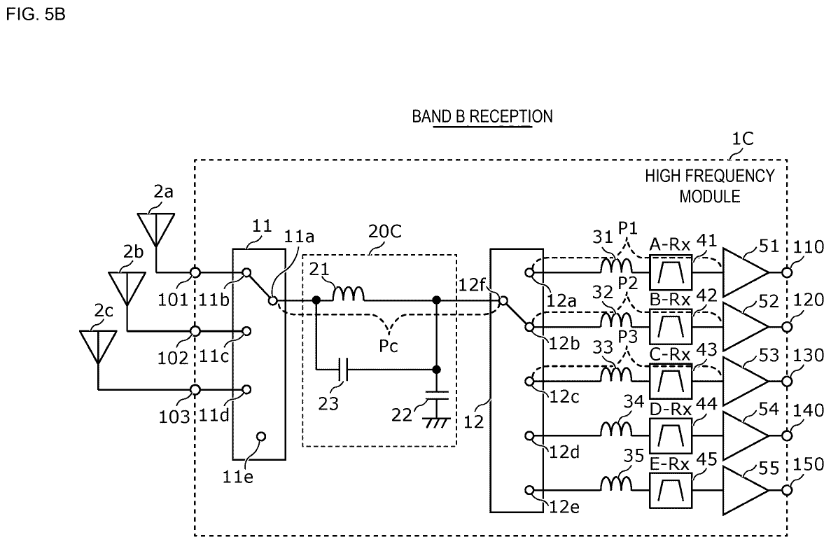

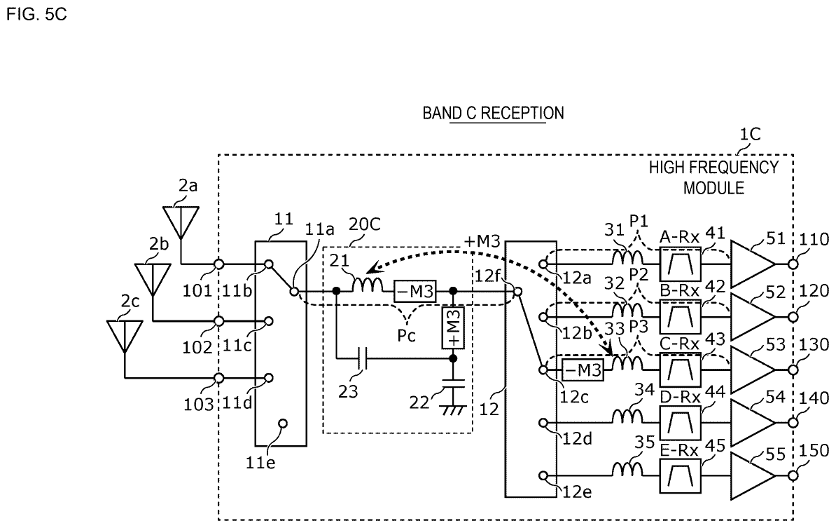

Next, a circuit configuration and bandpass characteristics of a radio frequency module 1C according to a third modification of the embodiment will be described. FIG. 5A is a circuit configuration diagram of the radio frequency module 1C according to the third modification of the embodiment for Band A reception. FIG. 5B is a circuit configuration diagram of the radio frequency module 1C according to the third modification of the embodiment for Band B reception. FIG. 5C is a circuit configuration diagram of the radio frequency module 1C according to the third modification of the embodiment for Band C reception. As illustrated in FIGS. 5A to 5C, the radio frequency module 1C includes switches 11 and 12, filters 41 to 45, inductors 21 and 31 to 35, capacitors 22 and 23, low noise amplifiers 51 to 55, antenna connection terminals 101 to 103, and signal output terminals 110 to 150. The radio frequency module 1C may include a coupler 60 disposed on the common path Pc. The radio frequency module 1C according to this modification is different from the radio frequency module 1 according to the embodiment in the circuit configuration of a low pass filter 20C. Hence, description of configuration features of the radio frequency module 1C according to this modification that are the same as those of the radio frequency module 1 according to the embodiment will be omitted, and different configuration features will be mainly described below.

The inductor 21 is an example of a first inductor and is connected to the common path Pc connecting the common terminal 11a to the common terminal 12f. More specifically, a first end of the inductor 21 is connected to the common terminal 11a, and a second end of the inductor 21 is connected to the common terminal 12f.

The capacitor 22 is an example of a first capacitor and is connected between the common path Pc and the ground. In this embodiment, the capacitor 22 is connected to the part of the common path Pc that is between the inductor 21 and the common terminal 12f. However, the capacitor 22 may be connected to the part of the common path Pc that is between the inductor 21 and the common terminal 11a.

The capacitor 23 is an example of a second capacitor and is connected in parallel to the inductor 21.

The inductor 21 and the capacitors 22 and 23 form the low pass filter 20C. The capacitor 22 is not necessarily provided.

The inductor 21 and the inductor 31 are configured in such a manner that magnetic field coupling can be achieved between the inductor 21 and the inductor 31. Furthermore, the inductor 21 and the inductor 33 are configured in such a manner that magnetic field coupling can be achieved between the inductor 21 and the inductor 33. The inductor 21 and the inductor 32 are configured in such a manner that magnetic field coupling is not achieved between the inductor 21 and the inductor 32.

As the configuration of the radio frequency module 1C described above in which magnetic field coupling is achieved or is not achieved between the inductor 21 and each of the inductors 31 to 33, for example, arrangement configurations A to C described below are considered. The radio frequency module 1C further includes a module substrate 70 that has main surfaces 70a and 70b that are opposite to each other.

### Arrangement Configuration A

The inductors 21 and 31 to 33 are disposed on the main surface 70a, the winding axis positive direction of the inductor 21 and the winding axis positive direction of the inductor 31 are the same, and the winding axis positive direction of the inductor 21 and the winding axis negative direction of the inductor 33 are the same. The distance D₃₁ between the inductor 21 and the inductor 31 is shorter than the distance D₃₂ between the inductor 21 and the inductor 32.

### Arrangement Configuration B

The inductors 21 and 31 to 33 are disposed on the main surface 70a, the winding axis positive direction of the inductor 21 and the winding axis positive direction of the inductor 31 are the same, the winding axis positive direction of the inductor 21 and the winding axis negative direction of the inductor 33 are the same, and the angle formed between the winding axis positive direction of the inductor 21 and the winding axis positive direction of the inductor 32 is 90 degrees.

### Arrangement Configuration C

The inductors 21 and 31 to 33 are disposed on the main surface 70a, the winding axis positive direction of the inductor 21 and the winding axis positive direction of the inductor 31 are the same, and the winding axis positive direction of the inductor 21 and the winding axis negative direction of the inductor 33 are the same. Furthermore, a ground metal plate is provided upright on the module substrate 70 so as not to include the inductor 32 but to surround the inductors 21, 31, and 33.

Next, regarding the radio frequency module 1C, a case (1) where a signal in Band A is received (Band A reception mode), a case (2) where a signal in Band B is received (Band B reception mode), and a case (3) where signals in Band C are received at the same time (Band C reception mode) will be described with reference to FIGS. 5A, 5B, and 5C, respectively.

First, as illustrated in FIG. 5A, in the Band A reception mode (1), the common terminal 11a and the selection terminal 11b are connected, and the common terminal 12f and the selection terminal 12a are connected. In this circuit state, a signal in Band A travels through the antenna 2a, the switch 11, the low pass filter 20C, the switch 12, the inductor 31, the filter 41, and the low noise amplifier 51 and is output through the signal output terminal 110. At this time, since the signal travels through the inductors 21 and 31, magnetic field coupling is achieved between the inductors 21 and 31, and a mutual inductance (+M1) is thus generated. Accordingly, in the low pass filter 20C, the inductance of +M1 is equivalently added in series to the common path Pc, the inductance of −M1 is equivalently added in series to a shunt path that connects the common path Pc to the capacitor 22, and the inductance of +M1 is equivalently added in series to the signal path P1.

In the Band A reception mode (1), a signal in Band A is not necessarily received by the antenna 2a. A signal in Band A may be received by the antenna 2b or 2c. In this case, the common terminal 11a and the selection terminal 11c are connected or the common terminal 11a and the selection terminal 11d are connected.

Next, as illustrated in FIG. 5B, in the Band B reception mode (2), the common terminal 11a and the selection terminal 11b are connected, and the common terminal 12f and the selection terminal 12b are connected. In this circuit state, a signal in Band B travels through the antenna 2a, the switch 11, the low pass filter 20C, the switch 12, the inductor 32, the filter 42, and the low noise amplifier 52 and is output through the signal output terminal 120. At this time, although the signal travels through the inductors 21 and 32, since the arrangement configuration of the inductor 21 and the inductor 32 is such that magnetic field coupling is not achieved between the inductor 21 and the inductor 32, no mutual inductance is generated between the inductor 21 and the inductor 32.

In the Band B reception mode (2), a signal in Band B is not necessarily received by the antenna 2a. A signal in Band B may be received by the antenna 2b or 2c. In this case, the common terminal 11a and the selection terminal 11c are connected or the common terminal 11a and the selection terminal 11d are connected.

Next, as illustrated in FIG. 5C, in the Band C reception mode (3), the common terminal 11a and the selection terminal 11b are connected, and the common terminal 12f and the selection terminal 12c are connected. In this circuit state, a signal in Band C travels through the antenna 2a, the switch 11, the low pass filter 20C, the switch 12, the inductor 33, the filter 43, and the low noise amplifier 53 and is output through the signal output terminal 130. At this time, since the signal travels through the inductors 21 and 33, magnetic field coupling is achieved between the inductor 21 and the inductor 33, and a mutual inductance (−M3) is thus generated. Accordingly, in the low pass filter 20C, the inductance of −M3 is equivalently added in series to the common path Pc, the inductance of +M3 is equivalently added in series to a shunt path that connects the common path Pc to the capacitor 22, and the inductance of −M3 is equivalently added in series to a signal path P3 that connects the selection terminal 12c to the filter 43.

In the Band C reception mode (3), a signal in Band C is not necessarily received by the antenna 2a. A signal in Band C may be received by the antenna 2b or 2c. In this case, the common terminal 11a and the selection terminal 11c are connected or the common terminal 11a and the selection terminal 11d are connected.

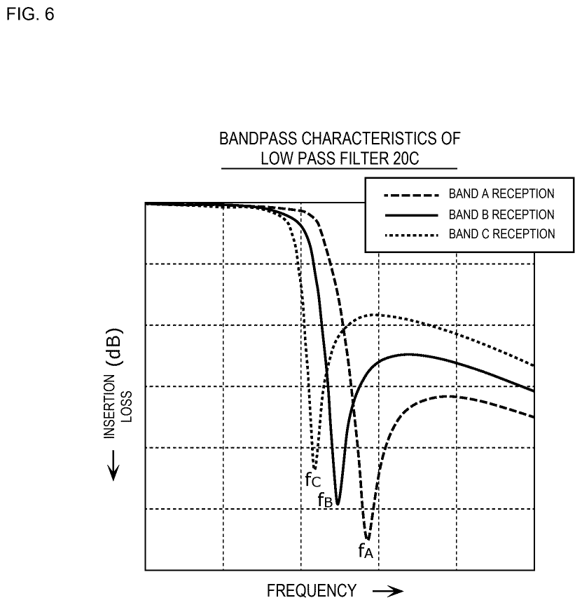

FIG. 6 is a graph indicating bandpass characteristics of the low pass filter 20C of the radio frequency module 1C according to the third modification of the embodiment. In FIG. 6, bandpass characteristics of the low pass filter 20C in the Band A reception mode (1), the Band B reception mode (2), and the Band C reception mode (3) are illustrated.

In the case of the Band A reception mode, an equivalent inductor having the inductance of −M1 is added between the common path Pc and the ground, and due to a resonance circuit including the equivalent inductor, a first attenuation pole of a frequency f_{A} is formed in the bandpass characteristics.

In the case of the Band B reception mode, an equivalent inductor, which is generated by magnetic field coupling, is not added between the common path Pc and the ground, and due to a resonance circuit not including the equivalent inductor, a second attenuation pole of a frequency f_{B}, which is lower than the frequency of the first attenuation pole, is formed in the bandpass characteristics.

In the case of the Band C reception mode, an equivalent inductor having the inductance of +M3 is added between the common path Pc and the ground, and due to a resonance circuit including the equivalent inductor, a third attenuation pole of a frequency f_{C}, which is lower than the frequency of the second attenuation pole, is formed in the bandpass characteristics.

Accordingly, due to the magnetic field coupling between the inductors 21 and 31, the negative inductance (−M1) can be obtained, an equivalent inductor with no resistance component can be added between the common path Pc and the capacitor 22, and the sharp first attenuation pole can be generated. Furthermore, due to the magnetic field coupling between the inductors 21 and 33, the positive inductance (+M3) can be obtained, an equivalent inductor with no resistance component can be added between the common path Pc and the capacitor 22, and the sharp third attenuation pole can be generated. Thus, the frequency at which an attenuation pole is generated can be made different between the magnetic field coupling between the inductors 21 and 31 and the magnetic field coupling between the inductors 21 and 33.

For example, in the case where there is a band relationship in which frequencies of Band A are higher than frequencies of Band B and the frequencies of Band B are higher than frequencies of Band C, by setting the frequencies to f_{A}>f_{B}>f_{C}, a higher frequency end of the pass band of the low pass filter 20C can be shifted according to band frequencies. Therefore, loss of signals in the individual bands can be reduced. That is, by achieving magnetic field coupling between the inductor 21 of the low pass filter 20C and each of the inductors 31 to 35 disposed on individual signal paths, the pass band width of the low pass filter 20C, the frequency of an attenuation pole, and the like can be optimized for each of the signal paths for Bands A to E.

Furthermore, in the radio frequency module 1C according to this modification, the plurality of signal paths that connect the antennas 2a to 2c to the filters 41 to 45 share the common path Pc, and the single low pass filter 20C is disposed on the common path Pc. Accordingly, no chip-like inductor is connected to the path that connects the antenna connection terminal 101 to the switch 11, the path that connects the antenna connection terminal 102 to the switch 11, or the path that connects the antenna connection terminal 103 to the switch 11.

Thus, since matching circuits for achieving impedance matching between the antennas 2a to 2c and the radio frequency module 1C can share the low pass filter 20C, the size of the radio frequency module 1C can be reduced.

### 6 Configuration of Radio Frequency Module 1D According to Fourth Modification

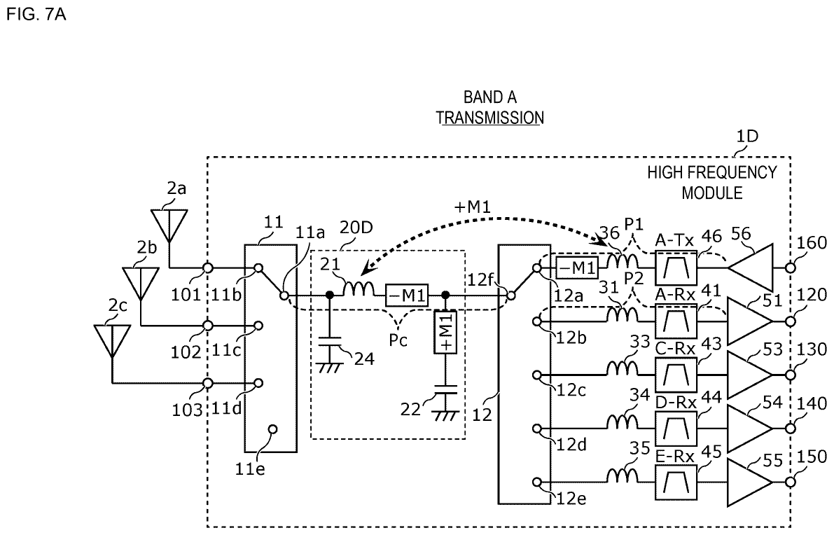

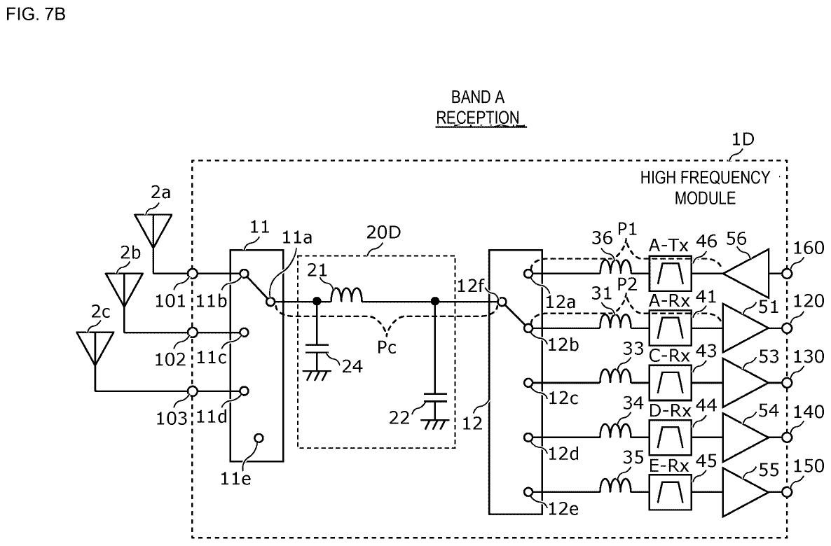

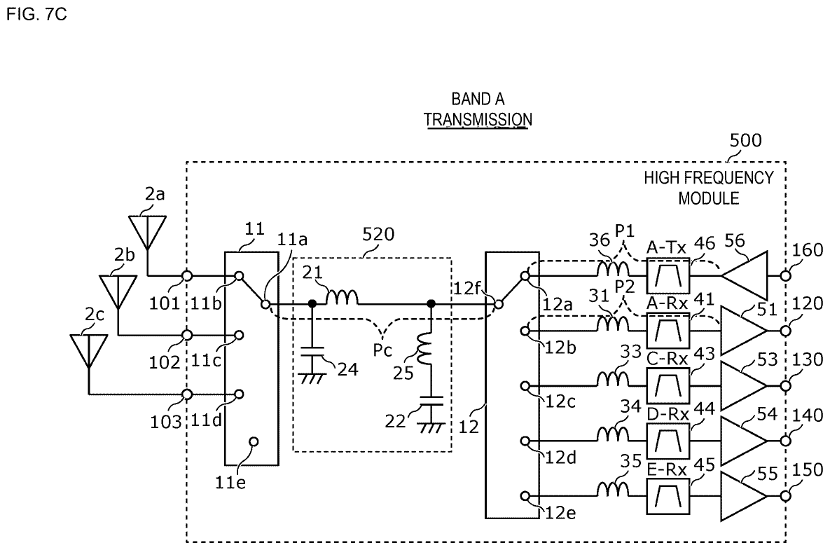

Next, a circuit configuration and bandpass characteristics of a radio frequency module 1D according to a fourth modification of the embodiment will be described. FIG. 7A is a circuit configuration diagram of the radio frequency module 1D according to the fourth modification of the embodiment for Band A transmission. FIG. 7B is a circuit configuration diagram of the radio frequency module 1D according to the fourth modification of the embodiment for Band A reception. As illustrated in FIGS. 7A and 7B, the radio frequency module 1D includes switches 11 and 12, filters 41 and 43 to 46, inductors 21, 31, and 33 to 36, capacitors 22 and 24, low noise amplifiers 51 and 53 to 55, a power amplifier 56, antenna connection terminals 101 to 103, signal output terminals 120 to 150, and a signal input terminal 160. The radio frequency module 1D may include a coupler 60 that is disposed on the common path Pc. The radio frequency module 1D according to this modification is different from the radio frequency module 1 according to the embodiment in the configuration of a low pass filter 20D and a transmission circuit for Band A disposed in place of a reception circuit for Band B. Hence, description of configuration features of the radio frequency module 1D according to this modification that are the same as those of the radio frequency module 1 according to the embodiment will be omitted, and different configuration features will be mainly described below.

The signal input terminal 160 is connected to an input end of the power amplifier 56. The signal output terminal 120 is connected to an output end of the low noise amplifier 51.

The filter 46 is an example of a first filter and has a pass band including a transmission band of Band A. A first end of the filter 46 is connected to the inductor 36, and a second end of the filter 46 is connected to an output end of the power amplifier 56.

The filter 41 is an example of a second filter and has a pass band including a reception band of Band A. A first end of the filter 41 is connected to the inductor 31, and a second end of the filter 41 is connected to the input end of the low noise amplifier 51.

The switch 12 includes a common terminal 12f and selection terminals 12a, 12b, 12c, 12d, and 12e. The common terminal 12f is connected to the common terminal 11a with the common path Pc interposed therebetween, the selection terminal 12a is connected to the inductor 36, the selection terminal 12b is connected to the inductor 31, the selection terminal 12c is connected to the inductor 33, the selection terminal 12d is connected to the inductor 34, and the selection terminal 12e is connected to the inductor 35.

The capacitor 24 is connected between the common path Pc and the ground.

The inductor 21 is an example of a first inductor and is connected to the common path Pc that connects the common terminal 11a to the common terminal 12f. More specifically, a first end of the inductor 21 is connected to the common terminal 11a, and a second end of the inductor 21 is connected to the common terminal 12f.

The inductor 36 is an example of a first inductor and is connected to the signal path P1 (first path) that connects the selection terminal 12a to the filter 46. More specifically, a first end of the inductor 36 is connected to the selection terminal 12a, and a second end of the inductor 36 is connected to the filter 46. The inductor 36 may be connected between the signal path P1 and the ground.

The inductor 31 is an example of a second inductor and is connected to the signal path P2 (second path) that connects the selection terminal 12a to the filter 41. More specifically, a first end of the inductor 31 is connected to the selection terminal 12a, and a second end of the inductor 31 is connected to the filter 41. The inductor 31 may be connected between the signal path P2 and the ground.

The inductor 21 and the capacitors 22 and 24 form the low pass filter 20D. The capacitors 22 and 24 are not necessarily provided. Furthermore, the inductor 21 may be connected between the common path Pc and the ground. Furthermore, in the case where neither the capacitor 22 nor the capacitor 24 is provided, the inductor 21 may function as an impedance matching circuit.

The inductor 21 and the inductor 36 are configured in such a manner that magnetic field coupling can be achieved between the inductor 21 and the inductor 36. Furthermore, the inductor 21 and the inductor 31 are configured in such a manner that magnetic field coupling is not achieved between the inductor 21 and the inductor 31.

The inductor 36 is connected to the signal path P1 that connects the selection terminal 12a to the filter 46. More specifically, a first end of the inductor 36 is connected to the selection terminal 12a, and a second end of the inductor 36 is connected to the filter 46. The inductor 36 may be connected between the signal path P1 and the ground.

The inductor 31 is connected to the signal path P2 that connects the selection terminal 12b to the filter 41. More specifically, a first end of the inductor 31 is connected to the selection terminal 12b, and a second end of the inductor 31 is connected to the filter 41. The inductor 31 may be connected between the signal path P2 and the ground.

An output end of the power amplifier 56 is connected to the filter 46, and an input end of the power amplifier 56 is connected to the signal input terminal 160. The input end of the low noise amplifier 51 is connected to the filter 41, and the output end of the low noise amplifier 51 is connected to the signal output terminal 120.

As the configuration of the radio frequency module 1D described above in which magnetic field coupling is achieved or is not achieved between the inductor 21 and each of the inductors 31 and 36, for example, arrangement configurations D to F described below are considered. The radio frequency module 1D further includes a module substrate 70 that has main surfaces 70a and 70b that are opposite to each other.

### Arrangement Configuration D

The inductors 21, 31, and 36 are disposed on the main surface 70a, and the winding axis positive direction of the inductor 21 and the winding axis negative direction of the inductor 36 are the same. The distance D₃₁ between the inductor 21 and the inductor 31 is longer than the distance D₃₆ between the inductor 21 and the inductor 36.

### Arrangement Configuration E

The inductors 21, 31, and 36 are disposed on the main surface 70a, the winding axis positive direction of the inductor 21 and the winding axis negative direction of the inductor 36 are the same, and the angle formed between the winding axis positive direction of the inductor 21 and the winding axis positive direction of the inductor 31 is 90 degrees.

### Arrangement Configuration F

The inductors 21, 31, and 36 are disposed on the main surface 70a, and the winding axis positive direction of the inductor 21 and the winding axis negative direction of the inductor 36 are the same. Furthermore, a ground metal plate is provided upright on the main surface 70a so as not to include the inductor 31 but to surround the inductors 21 and 36.

Next, regarding the radio frequency module 1D, the case (1) where a signal in Band A is transmitted (Band A transmission mode) and the case (2) where a signal in Band A is received (Band A reception mode) will be described with reference to FIGS. 7A and 7B, respectively.

First, as illustrated in FIG. 7A, in the Band A transmission mode (1), the common terminal 11a and the selection terminal 11b are connected, and the common terminal 12f and the selection terminal 12a are connected. In this circuit state, a signal in Band A travels through the signal input terminal 160, the power amplifier 56, the filter 46, the inductor 36, the switch 12, the low pass filter 20D, and the switch 11 and is output from the antenna 2a. At this time, since the signal travels through the inductors 21 and 36, magnetic field coupling is achieved between the inductor 21 and the inductor 36, and a mutual inductance (−M1) is thus generated. Accordingly, in the low pass filter 20D, the inductance of −M1 is equivalently added in series to the common path Pc, the inductance of +M1 is equivalently added in series to a shunt path that connects the common path Pc to the capacitor 22, and the inductance of −M1 is equivalently added in series to the signal path P1.

In the Band A transmission mode (1), a signal in Band A is not necessarily transmitted from the antenna 2a. A signal in Band B may be transmitted from the antenna 2b or 2c. In this case, the common terminal 11a and the selection terminal 11c are connected or the common terminal 11a and the selection terminal 11d are connected.

Next, as illustrated in FIG. 7B, in the Band A reception mode (2), the common terminal 11a and the selection terminal 11b are connected, and the common terminal 12f and the selection terminal 12b are connected. In this circuit state, a signal in Band A travels through the antenna 2a, the switch 11, the low pass filter 20D, the switch 12, the inductor 31, the filter 41, and the low noise amplifier 51 and is output through the signal output terminal 120. At this time, although the signal travels through the inductors 21 and 31, since the arrangement configuration of the inductor 21 and the inductor 31 is such that magnetic field coupling is not achieved between the inductor 21 and the inductor 31, no mutual inductance is generated between the inductor 21 and the inductor 31.

In the Band A reception mode (2), a signal in Band A is not necessarily received by the antenna 2a. A signal in Band A may be received by the antenna 2b or 2c. In this case, the common terminal 11a and the selection terminal 11c are connected or the common terminal 11a and the selection terminal 11d are connected.

Next, a circuit configuration of a radio frequency module 500 according to a comparative example as a known configuration will be described. FIG. 7C is a circuit configuration diagram of the radio frequency module 500 according to the comparative example for Band A transmission. As illustrated in FIG. 7C, the radio frequency module 500 includes switches 11 and 12, filters 41 and 43 to 46, inductors 21, 25, 31, and 33 to 36, capacitor 22 and 24, low noise amplifiers 51 and 53 to 55, a power amplifier 56, antenna connection terminals 101 to 103, signal output terminals 120 to 150, and a signal input terminal 160. The radio frequency module 500 according to the comparative example is different from the radio frequency module 1D according to the fourth modification mainly in the configuration of a low pass filter 520. Hence, description of configuration features of the radio frequency module 500 according to the comparative example that are the same as those of the radio frequency module 1D according to the fourth modification will be omitted, and different configuration features will be mainly described below.

The inductor 25 is connected between the common path Pc and the capacitor 22. The inductors 21 and 25 and the capacitors 22 and 24 form the low pass filter 520.

The inductor 21 and the inductor 36 are configured in such a manner that magnetic field coupling is not achieved between the inductor 21 and the inductor 36. Furthermore, the inductor 21 and the inductor 31 are configured in such a manner that magnetic field coupling is not achieved between the inductor 21 and the inductor 31.

In the radio frequency module 500, as illustrated in FIG. 7C, in the Band A transmission mode (1), the common terminal 11a and the selection terminal 11b are connected, and the common terminal 12f and the selection terminal 12a are connected. In this circuit state, a signal in Band A travels through the signal input terminal 160, the power amplifier 56, the filter 46 the inductor 36, the switch 12, the low pass filter 520, and the switch 11 and is output from the antenna 2a. At this time, since magnetic field coupling is not achieved between the inductor 21 and the inductor 36, an inductance caused by magnetic field coupling between the inductor 21 and the inductor 36 is not added to the low pass filter 520. Therefore, in the radio frequency module 500, the inductor 25 is arranged as the circuit configuration.

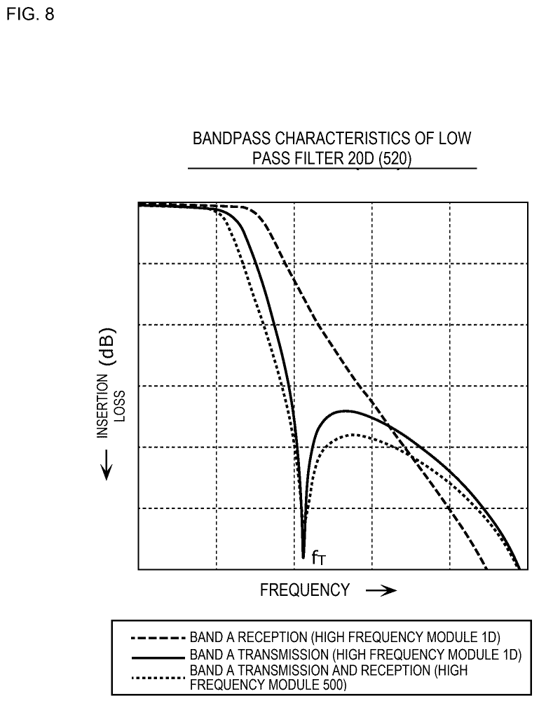

FIG. 8 is a graph indicating bandpass characteristics of the low pass filter 20D of the radio frequency module 1D according to the fourth modification of the embodiment and the low pass filter 520 of the radio frequency module 500 according to the comparative example. In FIG. 8, bandpass characteristics of the low pass filter 20D (520) in the Band A transmission mode (1) for the radio frequency module 1D, the Band A reception mode (2) for the radio frequency module 1D, and the Band A transmission mode and the Band A reception mode (3) for the radio frequency module 500 are illustrated.

In the case of the Band A transmission mode, in both the radio frequency modules 1D and 500, an attenuation pole of the frequency f_{T} is formed. In the radio frequency module 500, the inductor 25 and the capacitor 22 between the common path Pc and the ground form an LC series resonance circuit. In contrast, in the radio frequency module 1D, the equivalent inductor (+M1) and the capacitor 22 between the common path Pc and the ground form an LC series resonance circuit. Since the equivalent inductor added to the radio frequency module 1D does not have resistance loss, a high Q value of the LC series resonance circuit can be obtained. Therefore, the sharpness of the attenuation pole (frequency f_{T}) can be increased. Accordingly, insertion loss at a higher frequency end of the pass band of the low pass filter 20D in the radio frequency module 1D can be reduced (a so-called shoulder drop can be reduced) compared to the radio frequency module 500.

Furthermore, in the radio frequency module 1D, since the equivalent inductor mentioned above is not generated at the time of reception, insertion loss of the low pass filter 20D in the Band A reception mode can be reduced compared to the radio frequency module 500.

In the Band A reception mode of the radio frequency module 1D, the arrangement configuration of the inductors 21 and 32 may be such that a mutual inductance (+M2) is generated. Accordingly, an equivalent inductor of a mutual inductance (−M2) can be added between the common path Pc and the capacitor 22, and the insertion loss of the low pass filter 20D can further be reduced.

### 7 Effects and Others

As described above, the radio frequency module 1 according to the embodiment includes the switch 11 that includes the selection terminal 11b connected to the antenna 2a, the selection terminal 11c connected to the antenna 2b, and the common terminal 11a, the switch 12 that includes the selection terminals 12a and 12b and the common terminal 12f, the filters 41 and 42; the inductor 21 that is connected to the common path Pc connecting the common terminal 11a to the common terminal 12f, the inductor 31 that is connected to the signal path P1 connecting the selection terminal 12a to the filter 41, and the inductor 32 that is connected to the signal path P2 connecting the selection terminal 12b to the filter 42. The distance D₃₁ between the inductor 21 and the inductor 31 is shorter than the distance D₃₂ between the inductor 21 and the inductor 32.

Accordingly, the plurality of signal paths that connect the antennas 2a and 2b to the filters 41 and 42 share the common path Pc. In this case, magnetic field coupling can be achieved between the inductor 21 and the inductor 31 so that a mutual inductance (+M1) can be generated, and magnetic field coupling can be achieved between the inductor 21 and the inductor 32 so that a mutual inductance (+M2) that is different from the mutual inductance (+M1) can be generated. By causing the mutual inductances mentioned above to be generated, the inductance value of the common path Pc can be set larger than the inductance value of the inductor 21, the inductance value of the signal path P1 can be set larger than the inductance value of the inductor 31, and the inductance value of the signal path P2 can be set larger than the inductance value of the inductor 32. Therefore, since the inductance values of the inductors 21 and 31 can be decreased by the mutual inductance (+M1) and the inductance values of the inductors 21 and 32 can be decreased by the mutual inductance (+M2), resistance loss in the inductors 21, 31, and 32 can be reduced, and transmission loss of signals in multiple bands traveling through the common path Pc and the signal paths P1 and P2 can be reduced. Furthermore, since the inductor 21 disposed on the common path Pc is shared and magnetic field coupling can be achieved in each of the plurality of signal paths, the size of the radio frequency module 1 can be reduced.

Furthermore, for example, in the radio frequency module 1, the winding axis positive direction of the inductor 21, the winding axis positive direction of the inductor 31, and the winding axis positive direction of the inductor 32 are the same.

Accordingly, the mutual inductance (+M1) can be set larger than the mutual inductance (+M2).

Furthermore, for example, the radio frequency module 1A according to the first modification includes the switch 11 that includes the selection terminal 11b connected to the antenna 2a, the selection terminal 11c connected to the antenna 2b, and the common terminal 11a, the switch 12 that includes the selection terminals 12a and 12b and the common terminal 12f, the filters 41 and 42, the inductor 21 that is connected to the common path Pc connecting the common terminal 11a to the common terminal 12f, the inductor 31 that is connected to the signal path P1 connecting the selection terminal 12a to the filter 41, and the inductor 32A that is connected to the signal path P2 connecting the selection terminal 12b to the filter 42. The angle formed between the winding axis positive direction of the inductor 21 and the winding axis positive direction of the inductor 31 is smaller than the angle formed between the winding axis positive direction of the inductor 21 and the winding axis positive direction of the inductor 32A.

Accordingly, the plurality of signal paths that connect the antennas 2a and 2b to the filters 41 and 42 share the common path Pc. In this case, magnetic field coupling can be achieved between the inductor 21 and the inductor 31 so that a mutual inductance (+M1) can be generated, and magnetic field coupling can be achieved between the inductor 21 and the inductor 32A so that a mutual inductance (+M2) that is different from the mutual inductance (+M1) can be generated. By causing the mutual inductances mentioned above to be generated, the inductance value of the common path Pc can be set larger than the inductance value of the inductor 21, the inductance value of the signal path P1 can be set larger than the inductance value of the inductor 31, and the inductance value of the signal path P2 can be set larger than the inductance value of the inductor 32A. Therefore, resistance loss in the inductors 21, 31, and 32A can be reduced, and transmission loss of signals in multiple bands traveling through the common path Pc and the signal paths P1 and P2 can be reduced. Furthermore, since the inductor 21 disposed on the common path Pc is shared and magnetic field coupling can be achieved in each of the plurality of signal paths, the size of the radio frequency module 1A can be reduced.

Furthermore, for example, in the radio frequency module 1A, the winding axis positive direction of the inductor 21 and the winding axis positive direction of the inductor 31 are the same, the winding axis positive direction of the inductor 21 and the winding axis negative direction of the inductor 32 are the same, and the distance D₃₁ between the inductor 21 and the inductor 31 is shorter than the distance D₃₂ between the inductor 21 and the inductor 32A.

Accordingly, the mutual inductance (+M1) can be set larger than the mutual inductance (−M2).

Furthermore, for example, the radio frequency module 1B according to the second modification includes the switch 11 that includes the selection terminal 11b connected to the antenna 2a, the selection terminal 11c connected to the antenna 2b, and the common terminal 11a, the switch 12 that includes the selection terminals 12a and 12b and the common terminal 12f, the filters 41 and 42, the inductor 21 that is connected to the common path Pc connecting the common terminal 11a to the common terminal 12f, the inductor 31 that is connected to the signal path P1 connecting the selection terminal 12a to the filter 41, the inductor 32 that is connected to the signal path P2 connecting the selection terminal 12b to the filter 42, and a metal member that is disposed between the inductor 21 and the inductor 32.

Accordingly, the plurality of signal paths that connect the antennas 2a and 2b to the filters 41 and 42 share the common path Pc. In this case, magnetic field coupling can be achieved between the inductor 21 and the inductor 31 so that a mutual inductance (+M1) can be generated, and magnetic field coupling can be achieved between the inductor 21 and the inductor 32 so that a mutual inductance (+M2) that is different from the mutual inductance (+M1) can be generated. By causing the mutual inductances mentioned above to be generated, the inductance value of the common path Pc can be set larger than the inductance value of the inductor 21, the inductance value of the signal path P1 can be set larger than the inductance value of the inductor 31, and the inductance value of the signal path P2 can be set larger than the inductance value of the inductor 32. Therefore, resistance loss in the inductors 21, 31, and 32 can be reduced, and transmission loss of signals in multiple bands traveling through the common path Pc and the signal paths P1 and P2 can be reduced. Furthermore, since the inductor 21 disposed on the common path Pc is shared and magnetic field coupling can be achieved in each of the plurality of signal paths, the size of the radio frequency module 1B can be reduced.

Furthermore, for example, the radio frequency module 1B further includes the module substrate 70 that has the main surfaces 70a and 70b that are opposite to each other. The inductors 21, 31, and 32 are disposed on the main surface 70a. The metal member is the ground metal plate 93 that is provided upright between the inductors 21 and 31 and the inductor 32 when the main surface 70a is seen in plan view.

Accordingly, the mutual inductance (+M1) can be set larger than the mutual inductance (+M2).

Furthermore, for example, in the radio frequency modules 1, 1A, and 1B, the switches 11 and 12 are included in the semiconductor IC 81, the inductors 21, 31, and 32 are disposed on the main surface 70a, and the semiconductor IC 81 is disposed on the main surface 70b.

Accordingly, since the inductors 21, 31, and 32 and the switches 11 and 12 are disposed on both surfaces of the module substrate 70 in a distributed manner, the size of the radio frequency modules 1, 1A, and 1B can be reduced.

Furthermore, for example, in the radio frequency modules 1, 1A, and 1B, in the case where the module substrate 70 is seen in plan view, at least one of the inductors 31 and 32 and the semiconductor IC 81 overlap.

Accordingly, since a wire connected to a selection terminal side of the switch 12 can be shortened, transmission loss in the radio frequency modules 1, 1A, and 1B can be reduced.

Furthermore, for example, in the radio frequency modules 1, 1A, and 1B, in the case where the module substrate 70 is seen in plan view, the inductor 21 and the semiconductor IC 81 overlap.

Accordingly, since a wire connected to a common terminal side of the switch 12 can be shortened, transmission loss in the radio frequency modules 1, 1A, and 1B can be reduced.

Furthermore, for example, in the radio frequency modules 1, 1A, and 1B, a first end of the inductor 21 is connected to the common terminal 11a, a second end of the inductor 21 is connected to the common terminal 12f, and the radio frequency modules 1, 1A, and 1B further include the capacitor 22 that is connected between the common path Pc and the ground.

Accordingly, the inductor 21 and the capacitor 22 form the low pass filter 20, and by switching of connection of the switch 12, a first mutual inductance or a second mutual inductance can be generated. Thus, the pass band width of the low pass filter 20, the frequency of an attenuation pole, the amount of attenuation, and the like can be changed.

Furthermore, for example, the radio frequency module 1C according to the third modification further includes the capacitor 23 that is connected in parallel to the inductor 21.

Accordingly, due to the magnetic field coupling between the inductors 21 and 31, a negative mutual inductance (−M1) can be generated between the common path Pc and the capacitor 22, and an LC resonance caused by the mutual inductance (−M1) and the capacitor 22 can generate a sharp attenuation pole of the low pass filter 20C. Thus, the frequency at which an attenuation pole is generated can be made different between the magnetic field coupling between the inductors 21 and 31 and the magnetic field coupling between the inductors 21 and 32.

Furthermore, for example, in the radio frequency module 1C, in the case where the common terminal 12f and the selection terminal 12a are connected and the common terminal 12f and the selection terminal 12b are not connected, a first attenuation pole (f_{A}) is generated in the bandpass characteristics of the common path Pc. In the case where the common terminal 12f and the selection terminal 12a are not connected and the common terminal 12f and the selection terminal 12b are connected, a second attenuation pole (f_{B}) is generated at a frequency lower than a frequency of the first attenuation pole (f_{A}) in the bandpass characteristics of the common path Pc.

Accordingly, by achieving magnetic field coupling between the inductor 21 of the low pass filter 20C and each of the inductors 31 and 32 disposed on the signal paths P1 and P2, respectively, the pass band width of the low pass filter 20C, the frequency of an attenuation pole, and the like can be optimized for each of the signal paths.

Furthermore, for example, the radio frequency modules 1, 1A, 1B, and 1C further includes the coupler 60 that is disposed on the common path Pc.

Accordingly, since power of signals transmitted through the plurality of signal paths can be measured by disposing the single coupler 60, which measures power of a signal, on the common path Pc, the size of the radio frequency modules 1, 1A, 1B, and 1C can be reduced.

Furthermore, for example, the radio frequency modules 1, 1A, 1B, and 1C further include the antenna connection terminal 101 that is connected between the antenna 2a and the selection terminal 11b, and the antenna connection terminal 102 that is connected between the antenna 2b and the selection terminal 11c. No chip-like inductor is connected to a signal path connecting the antenna connection terminal 101 to the selection terminal 11b or a signal path connecting the antenna connection terminal 102 to the selection terminal 11c.

Accordingly, since a matching element for the antenna 2a and the radio frequency module 1 (and 1A, 1B, and 1C) and a matching element for the antenna 2b and the radio frequency module 1 (and 1A, 1B, and 1C) can share the inductor 21, the size of the radio frequency modules 1, 1A, 1B, and 1C can be reduced.

Furthermore, for example, in the radio frequency modules 1, 1A, 1B, and 1C, the switch 11 further includes the selection terminal lie that is connected to the diversity circuit 9 that is provided outside the radio frequency module 1 (and 1A, 1B, and 1C) and is capable of connecting to at least one of the selection terminals 11b and 11c.

Accordingly, since no inductor is disposed on a signal path connecting the antennas 2a and 2b to the diversity circuit 9, transmission loss in the signal path can be reduced.

### OTHER EMBODIMENTS AND OTHERS

Although radio frequency modules and communication apparatuses according to an embodiment of the present invention and modifications thereof have been described above, a radio frequency module and a communication apparatus according to the present invention is not limited to the embodiment and the modifications described above. Other embodiments implemented by combining component elements in the embodiment or modifications described device, modifications obtained by making various changes conceivable by those skilled in the art to the embodiments and modifications described above without departing from the spirit of the present invention, various types of equipment including the radio frequency module built therein are also included in the present invention.

For example, in the radio frequency modules and the communication apparatuses according to the embodiments and the modifications described above, other circuit elements, wires, or the like may be inserted between paths connecting circuit elements and signal paths disclosed in the drawings.

Features of radio frequency modules described above based on embodiments described above will be described below.

<1>

A radio frequency module comprising:
a first switch that includes a first selection terminal connected to a first antenna, a second selection terminal connected to a second antenna, and a first common terminal;
a second switch that includes a third selection terminal, a fourth selection terminal, and a second common terminal;
a first filter and a second filter;
a first inductor that is connected to a common path connecting the first common terminal to the second common terminal;
a second inductor that is connected to a first path connecting the third selection terminal to the first filter; and
a third inductor that is connected to a second path connecting the fourth selection terminal to the second filter,
wherein a distance between the first inductor and the second inductor is shorter than a distance between the first inductor and the third inductor.
   <2>

The radio frequency module according to <1>, wherein a winding axis positive direction of the first inductor, a winding axis positive direction of the second inductor, and a winding axis positive direction of the third inductor are the same.

<3>

A radio frequency module comprising:
a first switch that includes a first selection terminal connected to a first antenna, a second selection terminal connected to a second antenna, and a first common terminal;
a second switch that includes a third selection terminal, a fourth selection terminal, and a second common terminal;
a first filter and a second filter;
a first inductor that is connected to a common path connecting the first common terminal to the second common terminal;
a second inductor that is connected to a first path connecting the third selection terminal to the first filter; and
a third inductor that is connected to a second path connecting the fourth selection terminal to the second filter,
wherein an angle formed between a winding axis positive direction of the first inductor and a winding axis positive direction of the second inductor is smaller than an angle formed between the winding axis positive direction of the first inductor and a winding axis positive direction of the third inductor.
   <4>

The radio frequency module according to <3>,
wherein the winding axis positive direction of the first inductor and the winding axis positive direction of the second inductor are the same,
wherein the winding axis positive direction of the first inductor and a winding axis negative direction of the third inductor are the same, and
wherein a distance between the first inductor and the second inductor is shorter than a distance between the first inductor and the third inductor.
   <5>

A radio frequency module comprising:
a first switch that includes a first selection terminal connected to a first antenna, a second selection terminal connected to a second antenna, and a first common terminal;
a second switch that includes a third selection terminal, a fourth selection terminal, and a second common terminal;
a first filter and a second filter;
a first inductor that is connected to a common path connecting the first common terminal to the second common terminal;
a second inductor that is connected to a first path connecting the third selection terminal to the first filter;
a third inductor that is connected to a second path connecting the fourth selection terminal to the second filter; and
a metal member that is disposed between the first inductor and the third inductor.
   <6>

The radio frequency module according to <5>, further comprising:
a module substrate that has a first main surface and a second main surface that are opposite to each other,
wherein the first inductor, the second inductor, and the third inductor are disposed on the first main surface, and
wherein the metal member is a ground metal plate that is provided upright between the first inductor and the second inductor, and the third inductor when the first main surface is seen in plan view.
   <7>

The radio frequency module according to any one of <1> to <5>, further comprising:
a module substrate that has a first main surface and a second main surface that are opposite to each other,
wherein the first switch and the second switch are included in a first semiconductor integrated circuit (IC),
wherein the first inductor, the second inductor, and the third inductor are disposed on the first main surface, and
wherein the first semiconductor IC is disposed on the second main surface.
   <8>

The radio frequency module according to <7>, wherein in a case where the module substrate is seen in plan view, at least one of the second inductor and the third inductor and the first semiconductor IC overlap.

<9>

The radio frequency module according to <7>, wherein in a case where the module substrate is seen in plan view, the first inductor and the first semiconductor IC overlap.

<10>

The radio frequency module according to any one of <1> to <9>,
wherein a first end of the first inductor is connected to the first common terminal,
wherein a second end of the first inductor is connected to the second common terminal, and
wherein the radio frequency module further includes a first capacitor that is connected between the common path and a ground.
   <11>

The radio frequency module according to <10>, further comprising a second capacitor that is connected in parallel to the first inductor.

<12>

The radio frequency module according to <11>,
wherein in a case where the second common terminal and the third selection terminal are connected and the second common terminal and the fourth selection terminal are not connected, a first attenuation pole is generated in bandpass characteristics of the common path, and
wherein in a case where the second common terminal and the third selection terminal are not connected and the second common terminal and the fourth selection terminal are connected, a second attenuation pole is generated at a frequency lower than a frequency of the first attenuation pole in the bandpass characteristics of the common path.

<13>

The radio frequency module according to any one of <1> to <12>, further comprising a coupler that is disposed on the common path.

<14>

The radio frequency module according to any one of <1> to <13>, further comprising:
a first antenna connection terminal that is connected between the first antenna and the first selection terminal; and
a second antenna connection terminal that is connected between the second antenna and the second selection terminal,
wherein no chip-like inductor is connected to a path connecting the first antenna connection terminal to the first selection terminal or a path connecting the second antenna connection terminal to the second selection terminal.
   <15>

The radio frequency module according to <14>, wherein the first switch further includes an external connection terminal that is connected to an external circuit that is provided outside the radio frequency module and is capable of connecting to at least one of the first selection terminal and the second selection terminal.

The present invention can be widely used as a radio frequency module arranged in a front end part in a communication apparatus such as a mobile phone.

What is claimed is:

1. A radio frequency module comprising:
a first switch that includes a first selection terminal connected to a first antenna, a second selection terminal connected to a second antenna, and a first common terminal;
a second switch that includes a third selection terminal, a fourth selection terminal, and a second common terminal;
a first filter and a second filter;
a first inductor that is connected to a common path connecting the first common terminal to the second common terminal;
a second inductor that is connected to a first path connecting the third selection terminal to the first filter; and
a third inductor that is connected to a second path connecting the fourth selection terminal to the second filter,
wherein a distance between the first inductor and the second inductor is shorter than a distance between the first inductor and the third inductor.

2. The radio frequency module according to claim 1, wherein a winding axis positive direction of the first inductor, a winding axis positive direction of the second inductor, and a winding axis positive direction of the third inductor are the same.

3. A radio frequency module comprising:
a first switch that includes a first selection terminal connected to a first antenna, a second selection terminal connected to a second antenna, and a first common terminal;
a second switch that includes a third selection terminal, a fourth selection terminal, and a second common terminal;
a first filter and a second filter;
a first inductor that is connected to a common path connecting the first common terminal to the second common terminal;
a second inductor that is connected to a first path connecting the third selection terminal to the first filter; and
a third inductor that is connected to a second path connecting the fourth selection terminal to the second filter,
wherein an angle formed between a winding axis positive direction of the first inductor and a winding axis positive direction of the second inductor is smaller than an angle formed between the winding axis positive direction of the first inductor and a winding axis positive direction of the third inductor.

4. The radio frequency module according to claim 3,
wherein the winding axis positive direction of the first inductor and the winding axis positive direction of the second inductor are the same,
wherein the winding axis positive direction of the first inductor and a winding axis negative direction of the third inductor are the same, and
wherein a distance between the first inductor and the second inductor is shorter than a distance between the first inductor and the third inductor.

5. A radio frequency module comprising:
a first switch that includes a first selection terminal connected to a first antenna, a second selection terminal connected to a second antenna, and a first common terminal;
a second switch that includes a third selection terminal, a fourth selection terminal, and a second common terminal;
a first filter and a second filter;
a first inductor that is connected to a common path connecting the first common terminal to the second common terminal;
a second inductor that is connected to a first path connecting the third selection terminal to the first filter;
a third inductor that is connected to a second path connecting the fourth selection terminal to the second filter; and
a metal member that is disposed between the first inductor and the third inductor.

6. The radio frequency module according to claim 5, further comprising:
a module substrate that has a first main surface and a second main surface that are opposite to each other,
wherein the first inductor, the second inductor, and the third inductor are disposed on the first main surface, and
wherein the metal member is a ground metal plate that is provided upright between the first inductor and the second inductor, and the third inductor when the first main surface is seen in plan view.

7. The radio frequency module according to claim 1, further comprising:
a module substrate that has a first main surface and a second main surface that are opposite to each other,
wherein the first switch and the second switch are included in a first semiconductor integrated circuit (IC),
wherein the first inductor, the second inductor, and the third inductor are disposed on the first main surface, and
wherein the first semiconductor IC is disposed on the second main surface.

8. The radio frequency module according to claim 7, wherein in a case where the module substrate is seen in plan view, at least one of the second inductor and the third inductor and the first semiconductor IC overlap.

9. The radio frequency module according to claim 7, wherein in a case where the module substrate is seen in plan view, the first inductor and the first semiconductor IC overlap.

10. The radio frequency module according to claim 1,
wherein a first end of the first inductor is connected to the first common terminal,
wherein a second end of the first inductor is connected to the second common terminal, and
wherein the radio frequency module further includes a first capacitor that is connected between the common path and a ground.

11. The radio frequency module according to claim 10, further comprising a second capacitor that is connected in parallel to the first inductor.

12. The radio frequency module according to claim 11,
wherein in a case where the second common terminal and the third selection terminal are connected and the second common terminal and the fourth selection terminal are not connected in the second switch, a first attenuation pole is generated in bandpass characteristics of the common path, and
wherein in a case where the second common terminal and the third selection terminal are not connected and the second common terminal and the fourth selection terminal are connected in the second switch, a second attenuation pole is generated at a frequency lower than a frequency of the first attenuation pole in the bandpass characteristics of the common path.

13. The radio frequency module according to claim 1, further comprising a coupler that is disposed on the common path.

14. The radio frequency module according to claim 1, further comprising:
a first antenna connection terminal that is connected between the first antenna and the first selection terminal; and
a second antenna connection terminal that is connected between the second antenna and the second selection terminal,
wherein no chip-like inductor is connected to a path connecting the first antenna connection terminal to the first selection terminal or a path connecting the second antenna connection terminal to the second selection terminal.

15. The radio frequency module according to claim 14,
wherein the first switch further includes an external connection terminal that is connected to an external circuit that is provided outside the radio frequency module and is capable of connecting to at least one of the first selection terminal and the second selection terminal.

16. The radio frequency module according to claim 3, further comprising:
a module substrate that has a first main surface and a second main surface that are opposite to each other,
wherein the first switch and the second switch are included in a first semiconductor integrated circuit (IC),
wherein the first inductor, the second inductor, and the third inductor are disposed on the first main surface, and
wherein the first semiconductor IC is disposed on the second main surface.

17. The radio frequency module according to claim 5, further comprising:
a module substrate that has a first main surface and a second main surface that are opposite to each other,
wherein the first switch and the second switch are included in a first semiconductor integrated circuit (IC),
wherein the first inductor, the second inductor, and the third inductor are disposed on the first main surface, and
wherein the first semiconductor IC is disposed on the second main surface.

18. The radio frequency module according to claim 3,
wherein a first end of the first inductor is connected to the first common terminal,
wherein a second end of the first inductor is connected to the second common terminal, and
wherein the radio frequency module further includes a first capacitor that is connected between the common path and a ground.

19. The radio frequency module according to claim 5,
wherein a first end of the first inductor is connected to the first common terminal,
wherein a second end of the first inductor is connected to the second common terminal, and
wherein the radio frequency module further includes a first capacitor that is connected between the common path and a ground.

20. The radio frequency module according to claim 3, further comprising a coupler that is disposed on the common path.
